(19) United States
(12) Patent Application Publication
(10) Pub. No.: US 2022/0358523 A1
(43) Pub. Date: Nov. 10, 2022

(54) DIGITAL MARKETING MANAGEMENT METHOD AND SYSTEM

(71) Applicant: 3Q Digital, Inc., Chicago, IL (US)

(72) Inventors: Feliks Malts, Manalapan, NJ (US); Jacob Andrew Favaro, San Rafael, CA (US)

(21) Appl. No.: 17/737,242

(22) Filed: May 5, 2022

Related U.S. Application Data
(60) Provisional application No. 63/185,146, filed on May 6, 2021.
(60) Provisional application No. 63/247,032, filed on Sep. 22, 2021.

(51) Int. Cl. G06Q 30/02

(52) U.S. Cl. CPC G06Q 30/0201

(57) ABSTRACT

The present disclosure describes methods and systems of managing digital marketing plans. In an aspect, a media plan across digital marketing platforms can be added and managed. Assets of digital marketing content are received from a user to create a library for campaigns and advertisements at the digital marketing platforms. Advertisements may be automatically created and submitted to the platforms. Performance data on the campaigns and advertisements may also be retrieved. In addition, the user may be allowed to customize metrics defined by the variables from the performance data. The user may then review the status of the campaigns and get notification of alerts based on the performance date and the customizable metrics.

### TECHNICAL FIELD

The application relates to the field of information processing and more particularly relates to the field of digital advertisement and marketing.

### BACKGROUND

Digital marketing is the component of marketing that utilizes internet based digital technologies such as desktop computers, laptop computers, tablets, mobile phones, and other digital devices and platforms to promote products and services through digital media. The development of internet and smart mobile devices in the past few decades has changed the way brands and businesses use technology for marketing. As people increasingly use digital devices, digital marketing campaigns have become prevalent, employing combinations of search engine marketing, social media marketing, email marketing and so on.

Many internet related companies, especially those running social media are now offering their own digital marketing platforms, such as, Google Ads, Facebook Ads (including Networks of Facebook, Instagram, Messenger, etc.), LinkedIn Ads, Twitter Ads, TikTok for Business. On those digital marketing platforms, advertisers may bid to display advertisements, service offerings, or product listings to web users. Usually, digital marketing platforms do not share their media with one another. Therefore, businesses often have to register various accounts and manage their campaigns across the platforms.

There exist needs for a one-stop solution for businesses to manage campaigns across the various digital marketing platforms.

### SUMMARY

According to one aspect of the present invention, a digital marketing management method, implemented by at least one computing system, comprises: receiving an authorization to access at least one digital marketing platform that distributes digital marketing content to a consumer through a network; retrieving, from the at least one digital marketing platform, consumer interaction data describing an effect of consumer interaction with the digital marketing content; receiving, from the user, at least one customized metric which is calculated by a formula of the consumer interaction data; calculating the at least one customized metric; generating outcome data based on the customized metric and the consumer interaction data; and outputting a result based on the outcome data to the user. A digital marketing management system is also disclosed, comprising a management device connected to a network; and a user device connected to the network, comprising a user interface for a user to interact with the management device, wherein the management device comprises at least one processor and memory coupled to the at least one processor, the memory comprising computer executable instructions that, when executed by the at least one processor, performs the digital marketing management method according to one aspect of the present invention.

In the one aspect of the invention, the at least one customized metric may comprise a conditional metric that is calculated by a formula including logic operation. The method may further comprise outputting an alert to the user when, as an alert trigger, the conditional metric is true. The alert may further comprise an attention level information that indicates an attention level a user shall be called. The attention level information may be categorized based on a change of at least one of the customizable metric and the consumer interaction data, and a correspondence between the attention level information and the change of the at least one of the customizable metric and the consumer interaction data is received from the user. The digital marketing management method may further comprise receiving an alert group comprising a plurality of alert triggers that may be set by the user. The time and frequency and method of communication (e.g., prompt on a screen, email, or text message) of alert triggered by the alert triggers in the alert group may be set by the user, and at the predetermined time or frequency, if at least one alert is triggered, the digital marketing management method may send every and each triggered alert together as a grouped alert to the user. The alert may comprise at least one from the group including a prompt on a screen, a sound, an email sent to an email address designated by the user, and text sent to a phone number designated by the user. The alert may be sent repetitively at a time interval that the user is able to change. Retrieving consumer interaction data may comprise retrieving the consumer interaction data repetitively at a first preset time interval. The at least one metric comprises a metric that is calculated based on a change of the consumer interaction data over time. The consumer interaction data may comprise at least one from the group consisting of impressions, clicks, impression share, views, view rate, phone calls, interaction rate, cost, spend, conversion, conversion rate, and optimization score.

According to another aspect of the invention, a digital marketing management method comprises: receiving an authorization to access at least one digital marketing platform that distributes digital marketing content to an consumer through a network; receiving from the user an advertisement content library of at least one element required by the at least one digital marketing platform to form a digital marketing content, wherein the advertisement content library comprises at least one entry for each of the at least one element; generating at least one digital marketing content in a form required by the at least one digital marketing platform by selecting at least one entry from each element required by the form; and submitting the generated digital marketing content to the corresponding digital marketing platform. A digital marketing management system is also disclosed, comprising a management device connected to a network; and a user device connected to the network, comprising a user interface for a user to interact with the management device, wherein the management device comprises at least one processor and memory coupled to the at least one processor, the memory comprising computer executable instructions that, when executed by the at least one processor, performs the digital marketing management method according to another aspect of the present invention.

In another aspect of the invention, generating at least one digital marketing content may comprise generating a plurality of digital marketing content; and submitting the generated digital marketing content may further comprise receiving the user's selection of at least one selected digital marketing content from the generated digital marketing content and submitting the selected digital marketing content to the corresponding digital marketing. Generating at least one digital marketing content may comprise selecting at least one entry from each element based on permutations of the entries of the elements required by the corresponding digital marketing platform. The at least one element may comprise at least one selected from the group consisted of headline text, description text, image, video, video URL, image URL, and primary text. The method may further comprise: selecting at least two candidate digital marketing contents from the generated digital marketing contents; submitting the candidate digital marketing contents to run on the corresponding digital marketing platform for a predetermined time period; retrieving consumer interaction data describing an effect of consumer interaction with the respective candidate digital marketing contents; and deciding at least one recommended digital marketing content from the candidate digital marketing contents based on the consumer interaction data. Deciding at least one recommended digital marketing content may further comprise: deciding at least one index comprised in the consumer interaction data; deciding the at least one recommended digital marketing content based on the at least one index and corresponding weight.

In another aspect of the invention, a digital marketing management method, implemented by at least one computing system, comprises receiving an authorization to access at least one digital marketing platform that distributes digital marketing content to an consumer through a network; receiving from the user an advertisement content library of at least one element required by the at least one digital marketing platform to form a digital marketing content, wherein the advertisement content library comprises at least one entry for each of the at least one element; generating at least one digital marketing content in a form required by the at least one digital marketing platform by selecting at least one entry from each element required by the form; submitting the generated digital marketing content to the corresponding digital marketing platform; retrieving, from the at least one digital marketing platform, consumer interaction data describing an effect of consumer interaction with the digital marketing content; receiving, from the user, at least one customized metric which is calculated by a formula of the consumer interaction data; calculating the at least one customized metric; generating outcome data based on the customized metric and the consumer interaction data; and outputting a result based on the outcome data to the user. A digital marketing management system is also disclosed, comprising a management device connected to a network; and a user device connected to the network, comprising a user interface for a user to interact with the management device, wherein the management device comprises at least one processor and memory coupled to the at least one processor, the memory comprising computer executable instructions that, when executed by the at least one processor, performs the digital marketing management method according to another aspect of the present invention.

In another aspect of the invention, a digital marketing management method, implemented by at least one computing system, comprises: receiving an authorization to access at least one digital marketing platform that distributes digital marketing content to a consumer through a network; retrieving, from the at least one digital marketing platform, consumer interaction data describing an effect of consumer interaction with the digital marketing content; determining, if the retrieved consumer interaction data is complete; and if the retrieved consumer interaction data is not complete, continuing to retrieve a remaining part of the consumer interaction data that has not been retrieved. A digital marketing management system is also disclosed, comprising a management device connected to a network; and a user device connected to the network, comprising a user interface for a user to interact with the management device, wherein the management device comprises at least one processor and memory coupled to the at least one processor, the memory comprising computer executable instructions that, when executed by the at least one processor, performs the digital marketing management method according to another aspect of the present invention.

In another aspect of the invention, the digital marketing management method further comprises: recording a result of retrieval of the consumer interaction data in a log; and if the retrieved consumer interaction data is not complete, continuing to retrieve a remaining part of the consumer interaction data based on the log. The digital marketing management method may be performed at a prescheduled time or frequency.

In another aspect of the invention, a digital marketing management method, implemented by at least one computing system, comprises: receiving an authorization to access at least one digital marketing platform that distributes digital marketing content to a consumer through a network; retrieving, from the at least one digital marketing platform, consumer interaction data describing an effect of consumer interaction with the digital marketing content, the consumer interaction data comprises an attribution of the effect of consumer interaction corresponding to each source through which the digital marketing content is distributed; reattributing the effect of consumer interaction to each source based on a model. A digital marketing management system is also disclosed, comprising a management device connected to a network; and a user device connected to the network, comprising a user interface for a user to interact with the management device, wherein the management device comprises at least one processor and memory coupled to the at least one processor, the memory comprising computer executable instructions that, when executed by the at least one processor, performs the digital marketing management method according to another aspect of the present invention.

In another aspect of the invention, the model may be based on statistical analysis of historical data through factor analysis. The model may be trained using neural network on historical data. The source may be categorized based on at least one of platforms, channels, publisher, and campaigns. The consumer interaction date may comprise return on investment against spending in each source.

### BRIEF DESCRIPTION OF DRAWINGS

The foregoing summary, as well as the following detailed description of the preferred embodiments, will be better understood when read in conjunction with the appended drawings. It should be understood, however, that the invention is not limited to the precise arrangements and instrumentalities shown. In the drawings,

FIG. 1 illustrates an embodiment of a computing system environment in which an embodiment of the invention may be implemented;

FIG. 2 illustrates an embodiment of a network environment in which an embodiment of the present invention may be implemented;

FIG. 3 illustrates an example of multi-tier client server architecture in which an embodiment of the invention may be implemented;

FIG. 4 is a block diagram illustrating the function structure of a digital marketing management system according to an embodiment of the invention;

FIGS. 5A and 5B illustrate an exemplary user interface of the digital marketing management system for user management according to an embodiment of the invention, respectively;

FIG. 6 is a flow chart of the media planning and campaign automation routine according to an embodiment of the present invention;

FIGS. 7A-7D illustrate an exemplary user interface of the digital marketing management system for media planning and campaign automation according to an embodiment of the invention, respectively;

FIGS. 8A, 8B, 8E, and 8F illustrate an exemplary user interface for media planning and campaign automation according to an embodiment of the invention, respectively, while FIG. 8C illustrates an exemplary keyword search advertisement on Google Ads, and FIG. 8D illustrates an exemplary display advertisement on Facebook Ads;

FIG. 9 is a flow chart of the performance analysis routine according to an embodiment of the invention;

FIGS. 10A-10C illustrate an exemplary user interface for customizing metrics according to one embodiment of the present invention, respectively;

FIGS. 11A to 11C illustrate an exemplary user interface showing and customizing the outcome results according to an embodiment of the invention, respectively;

FIG. 12 illustrates an exemplary user interface for receiving alert setting from a user according to an embodiment of the invention;

FIG. 13 is a flow chart of automated decision maker routine according to an embodiment of the invention;

FIG. 14 illustrates an exemplary user interface enabling a user to make a bulk edit on a media plan according to one embodiment of the invention;

FIG. 15 illustrates an exemplary user interface showing performance outcome according to one embodiment of the invention;

FIG. 16 illustrates an exemplary user interface showing the alerts to the user in a visualized way according to one embodiment of the invention;

FIG. 17 illustrates an exemplary user interface that allows a user to set a complex condition for triggering an alert in a visualized way according to one embodiment of the invention;

FIG. 18 illustrates an exemplary user interface of the digital marketing management system according to an embodiment of the invention;

FIG. 19 illustrates a flow chart of data retrieval failsafe routine 1900 according to one embodiment of the invention; and

FIG. 20A-20C illustrates exemplary charts of media mix module according to one embodiment of the invention.

### DETAILED DESCRIPTION

A preferred embodiment will be set forth in detail with reference to the drawings, in which like reference numerals refer to like elements or steps throughout.

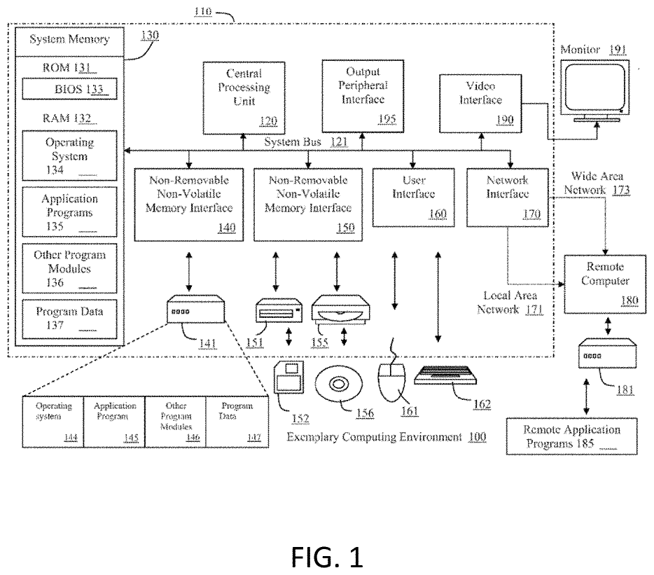

Below, examples of computing system, network environment, and client-server environment in which the embodiments of the present invention may be implemented are described by referring to FIGS. 1-3.

Example Computing Environment

FIG. 1 and the following discussion are intended to provide a brief general description of a suitable computing environment in which an example embodiment of the invention may be implemented. It should be understood, however, that handheld, portable, and other computing devices of all kinds (e.g., smartphones, tablets and laptops) are contemplated for use in connection with the preferred embodiment. While a general-purpose computer is described below, this is but one example. The preferred embodiment also may be operable on a thin client or mobile device having network server interoperability and interaction. Thus, an example embodiment of the invention may be implemented in an environment of networked hosted services in which very little or minimal client resources are implicated, e.g., an app or a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well-known computing systems, environments, and/or configurations that may be suitable for use with the invention include, but are not limited to, personal computers (PCs), server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which an embodiment of the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or a combination of components illustrated in the exemplary operating environment 100.

With reference to FIG. 1, an example system for implementing the invention includes a general-purpose computing device in the form of a computer 110. Components of the computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus (also known as Mezzanine bus), and PCI-Express bus.

The computer 110 typically includes a variety of computer readable media. Computer readable media can be any available media that can be accessed by the computer 110 and include both volatile and nonvolatile, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, solid state drives (SSD), or any other medium which can be used to store the desired information and which can be accessed by the computer 110. Communication media typically contain computer readable instructions, data structures, program modules or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 130 includes computer storage media in the form of volatile and/or nonvolatile memory such as ROM 131 and RAM 132. A basic input/output system 133 (BIOS), containing the basic routines that help to transfer information between elements within computer 110, such as during start-up, is typically stored in ROM 131. RAM 132 typically contains data and or program modules that are immediately accessible to and/or presently being operated on by the processing unit 120. By way of example, and not limitation, FIG. 1 illustrates operating system 134, application programs 135, other program modules 136, and program data 137. RAM 132 may contain other data and/or program modules.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical medium. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, the hard disk drive 141 is illustrated as the storing operating system 144, application programs 145, other program modules 146, and program data 147. Note that these components can either be the same as or different from the operating system 134, application programs 135, other program modules 136, and program data 137. Operating system 144, application programs 145, other program modules 146, and program data 147 are given different numbers here to illustrate that, at a minimum, they are different. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121 but may be connected by other interface and bus structures, such as a parallel port, game port or a universal serial bus (USB).

A monitor 191 or other type of display device is also connected to the system bus 121 via an interface, such as a video interface 190. In addition to a monitor 191, computers may also include other peripheral output devices such as speakers and a printer (not shown), which may be connected through an output peripheral interface 15.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections illustrated in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes means for establishing communications over the WAN 173, such as the Internet, hi a networked environment, program modules illustrated relative to the computer 110, or portions thereof, may be stored in the remote memory storage device. By way of example, and not limitation, FIG. 1 illustrates remote application programs 185 as residing on a memory device 181. Remote application programs 185 include, but are not limited to, web server applications such as Microsoft® Internet Information Services (ITS)® and Apache HTTP Server which provides content which resides on the remote storage device 181′ or other accessible storage device to the World Wide Web. It will be appreciated that the network connections shown are exemplary and other means of establishing a communications link between the computers may be used.

One of ordinary skill in the art can appreciate that a computer 110 or other client devices can be deployed as part of a computer network. In this regard, the preferred embodiment pertains to any computer system having any number of memory or storage units, and any number of applications and processes occurring across any number of storage units or volumes. An embodiment of the present invention may apply to an environment with server computers and client computers deployed in a network environment, having remote or local storage. The preferred embodiment may also apply to a standalone computing device, having programming language functionality, interpretation, and execution capabilities.

Example Network Environment

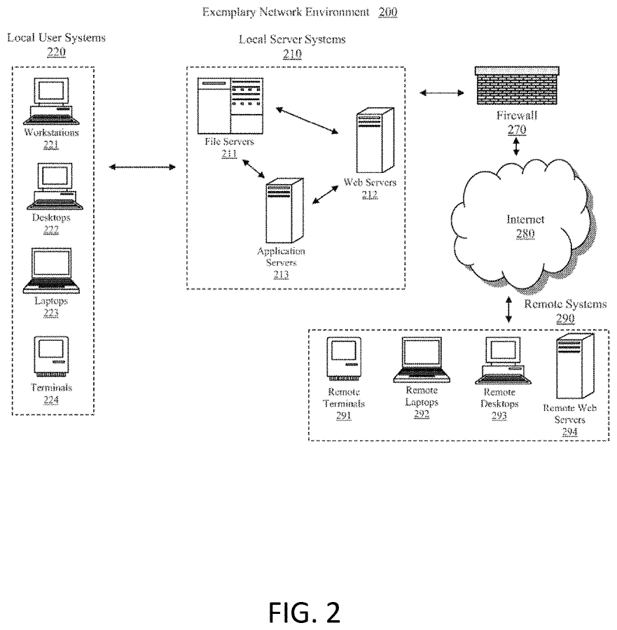

FIG. 2 illustrates an embodiment of a network environment in which an embodiment of the present invention can be implemented. The network environment 200 contains a number of local server systems 210, which may include a number of file servers 211, web servers 212, and application servers 213 that are owned and managed by the owner of the local network.

These servers are in communication with local user systems 220 which may include a large variety of systems such as workstations 221, desktop computers 222, laptop computers 223, and thin clients, smartphones, tablets, or terminals 224. The local user systems 220 may contain their own persistent storage devices such as in the case of workstations 221, desktop computers 222, and laptop computers 223. They can also have access to the persistent storage, such as a database, provide by the local servers 210. In the case of thin clients and terminals 224, network storage may be the only available persistent storage. The users within the local network usually get access to the wider area network such as the Internet 280 though the local server systems 210 and typically some network security measures such as a firewall 270. There might also be a number of remote systems 290 that can be in communication with the local server systems 210 and also the local user systems 220. The remote computer systems can be a variety of remote terminals 291, remote laptops 292, remote desktops 293, and remote web servers 294. FIG. 2 illustrates an exemplary network environment. Those of ordinary skill in the art will appreciate that the teaching of the present invention can be used with any number of network environments and network configurations.

Client-Server Environment

The client-server software architecture model is a versatile, message-based and modular infrastructure that is intended to improve usability, flexibility, interoperability, and scalability as compared to centralized, mainframe, time sharing computing. Client-server describes the relationship between two computer programs in which one program, the client is defined as a requester of services, which makes a service request from another program, the server is defined as the provider of services, which fulfills the request. A client-server application is a distributed system comprised of both client and server software. A client software process may initiate a communication session, while the server waits for requests from any client.

In a network, the client-server model provides a convenient way to efficiently interconnect programs that are distributed across different locations. Transactions among computers using the client-server model are very common. Most Internet applications, such as email, web access and database access, are based on the client-server model. For example, a web browser is a client program at a user computer that may be used to access information at any web server in the world. For a customer to check a bank account from a remote computer, a client program, which may run within a web browser, forwards a request to a web server program at the bank. The web server program may in turn forward the request to a database client program that sends a request to a database server at another bank computer to retrieve the requested account balance information. The balance information is returned to the bank database client, which in turn serves it back to the web browser client in the customer's computer, which displays the information to the customer.

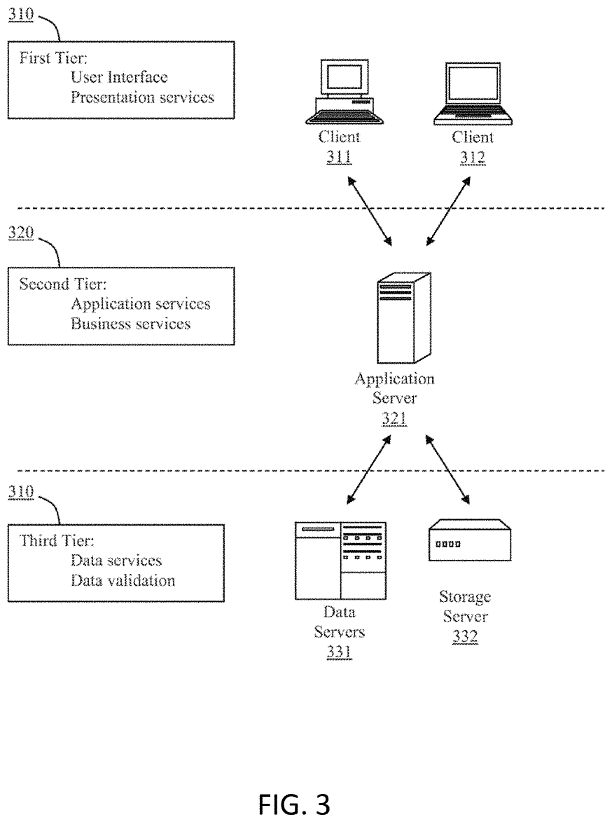

FIG. 3 illustrates an example of multi-tier client server architecture. Multi-tier client server architecture allocates different tasks and services to different tiers. In the example multi-tier architecture of FIG. 3, there are three logical tiers. The first tier 310 is one or more clients 311, 312, the second tier is an application server 321, and the third tier 330 is a data server 331 332. At the client tier, the clients 311, 312 provide the application's User Interface (UI) and also act as presentation servers. The application's graphical user interface is generally a custom-generated web page to be displayed by a web browser on the client computer. There can be one or more application servers 321 that host the business logic, and one or more data servers 331, 332 to provide data storage and validation services. The main body of an application is run on a shared host 321. The application server 321 does not drive the graphical user interface, rather it shares business logic, computations, and a data retrieval engine. The presentation of data retrieved is handled by the presentation server at the client tier. With less software on the client systems, there are fewer security concerns. Application scalability, support costs, and installation costs are all more favorable when the software is concentrated on a single server than when the software is distributed amongst a number of desktop clients.

The client-server architecture in the network environment also makes cloud computing possible. Specifically, cloud computing is the on-demand availability of computer system resources, especially data storage (cloud storage) and computing power, without direct active management by the user. Commercially available examples of cloud computing service include Amazon Web Services and Microsoft Azure.

Below, the embodiments of digital marketing management system and method according to the present invention will be described in detail by referring to the drawings. The term “user(s)” of the digital marketing management system and method in this disclosure, unless otherwise specified or understandable in the context, generally refers to any entity or individual that may access or use at least a part of the digital marketing management system or method according to the present invention. In practice, an entity user may further include one or more sub-entity users (for example, departments under the entity or a group of users for purpose of management and accessibility control) and/or one or more individual users. Sub-entity users and individual users may vary in their accessibilities but still fall in the general definition of “user”. A more detailed description will be provided later in, for example, the section of “User Management.”

In addition, the term “consumer(s),” unless otherwise specified or understandable in the context, generally refers to any recipient to whom a digital marketing platform delivers a digital marketing content (e.g., banners, links, anchor keywords on webpages, images and video advertisements on webpages or applications, keyword search advertisements, social media posts, among other digital marketing content). The examples of “consumer(s)” include but are not limited to any end user of a software application or website product (such as, Facebook, Instagram, WhatsApp, Google, YouTube, Tiktok, LinkedIn, SnapChat, WeChat, Telegram, Amazon, etc.) which allows a digital marketing platform to present an digital marketing content during the use of the corresponding product, and any end user of a hardware product (including but not limited to personal devices such as tablet, televisions, smart phones, ebook readers, and public devices, such as interactable information display) which allows a digital marketing platform to present an digital marketing content, regardless of whether the end user is an audience that is targeted by an algorism or not. In many cases, the term “consumer” is interchangeable with “audience” except that audience may be defined by some digital marketing platforms as the set of attributes that a digital marketer seeks to target consumers based on (such as age range, gender, household income, home ownership status), and consumer reflects an individual within that audience that an advertisement is delivered to and may then engage (e.g., view, interact with, click on, etc.) the advertisement.

In the embodiments of the present invention, the digital marketing management system and method provide a one-stop and easy-to-use tool managing and analyzing campaigns and advertisements across various digital marketing platforms. The digital marketing management system and method are designed to be implemented by at least one computing system, an example of which is shown by FIG. 1 and discussed above, in a network environment, an example of which is shown by FIG. 2 and discussed above. The digital marketing management system and method may also be implemented by a cloud computing system. The digital marketing management system and method receive and output data from and to a user and at least one digital marketing platform in a client-server environment, an example of which is shown by FIG. 3 and discussed above. In the embodiments of the present invention, when the digital marketing management system and method receive and output data from and to a user, the digital marketing management system and method may be implemented as the server side, while the user may use a terminal or a computing system as the client side. On the contrary, when the digital marketing management system and method receive and output data from and to a digital marketing platform, the digital marketing management system and method may be implemented as the client side, while the digital marketing platform functions as the server side.

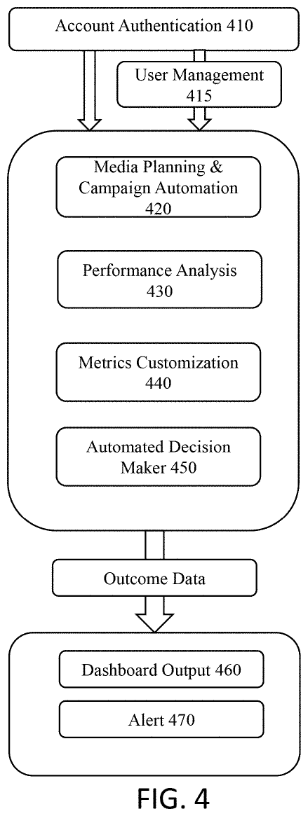

FIG. 4 is a block diagram illustrating the function structure of the digital marketing management system 400 according to one embodiment of the present invention. As shown by FIG. 4, the digital marketing management system 400 comprises user authorization module 410, campaign management module 420, performance analysis module 430, metrics customization module 440, assisted decision maker module 450, dashboard output module 460, and alert module 470. Not shown in FIG. 4, the digital marketing management system 400 may optionally comprise additional modules providing additional function to the user. Some examples will be described later.

Account Authorization

In one embodiment, the account authorization module 410 is configured to receive an authorization from a user to access one or more accounts in one or more digital marketing platforms that the user chooses. In one embodiment, the account authorization module 410 provides a list of optional digital marketing platforms that allow a third-party access, such as Google Ads, Facebook Ads, LinkedIn Ads, and so on. Users of the digital marketing management system 400 may then use their respective account credentials corresponding to the respective digital marketing platforms to grant the digital marketing management system 400 the accessibility of the account information, including campaign content and corresponding performance data, which will be discussed in detail below.

The authorization is performed through the protocol that is compatible with the corresponding digital marketing platforms, for example, OAuth 2.0. OAuth 2.0 is the industry-standard protocol for authorization that provides specific authorization flows for web applications, desktop applications, mobile phones, and other smart devices. Under OAuth 2.0, the account authorization module 410 requests a token from a digital marketing platform with the account credential provided by the user. The token is an encrypted information that can be used as a key instead of login credentials to access the corresponding account in the corresponding digital marketing platform. A token from some digital marketing platforms may further comprise multiple tokens to access different content related to the account. Depending on the requirement of a digital marketing platform, the token will usually be expired and need to be refreshed in certain circumstances, such as, when the user changes the login credential, or when the token has not been used for a predetermined period of time.

In one embodiment, depending on the security policy and user preference, the digital marketing management system 400 may store the account credentials that the user provided, for example, in an encrypted manner. By doing so, the digital marketing management system 400 will be able to refresh or renew the account authorization from the corresponding digital marketing platform without having to request input of the account credentials from the user. In another embodiment, the digital marketing management system 400 may also only store the tokens when the user authorizes the access of one or more digital marketing platform accounts. In this case, when a token is expired, the digital marketing management system 400 has to request again the account authorization from the user in order to access the corresponding digital marketing platform account. In either case, when the user is an entity that include a plurality of individual users, the platform account credentials, or tokens may be managed and stored under the entity as a single access point. The digital marketing management system 400 will distribute the accessibility of a platform account to individual users under the entity, based on each individual user's accessibility settings.

The user is usually required to register respective accounts in the respective digital marketing platforms in advance. Alternatively, the user may also newly register the account when prompted by the digital marketing management system during authorization.

After the authorization, the digital marketing management system 400 will be able to run some of the modules including medium planning and campaign automation module 420 and performance analysis module 430, among the others.

User Management

Optionally, the digital marketing management system 400 in the present embodiment may further comprise a user management module 415, when there are a plurality of users, to manage and control accessibility of the users. For example, when a company or entity becomes a client of the digital marketing management system, there may be multiple users (a client group) intended by the client to access the digital marketing management system. These users may vary in their accessibilities of the functional modules of the digital marketing management system 400 and the media plans or campaigns that are created under the client. For example, some users may be allowed to access the media plan or campaign data (which will be explained later) related to all of the authorized digital marketing platform accounts while others may be allowed to access those related to one or some of the authorized digital marketing platform accounts. Some users may be only allowed to read and view the status and output data while other users may be further allowed to edit the settings or add new media plans, campaigns or advertisements. The user management module 415 is configured to perform at least one of the following: adding a new user; editing an existing user; adding or removing a user from a specific digital platform account; enabling or disabling a user to add or change settings of a digital marketing account, a campaign, and so on; adding or changing a group of users and adding or deleting users to or from the group; and adding or changing the accessibility of a user group to a digital platform account or campaign. In one embodiment, only one or some of the users are granted the accessibility of aforementioned user management module 415, which will be referred to as administrators.

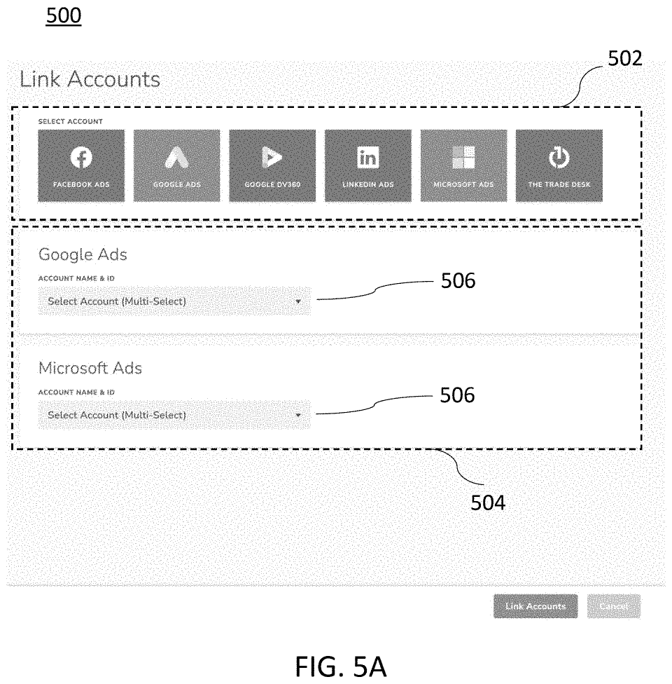

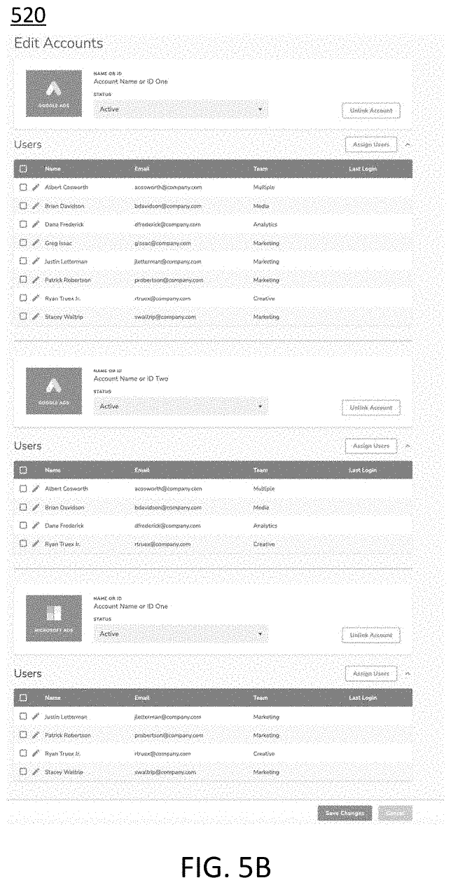

FIGS. 5A and 5B illustrate an exemplary user interface 500 of the digital marketing management system 400 for an administrator to grant or change access of a digital platform account to one or more users. As shown in FIG. 5A, the user interface 500 includes a block 502 listing all the digital marketing platforms that are authorized by an administrator. For example, in FIG. 5, Facebook Ads, Google Ads, Google DV360, LinkedIn Ads, Microsoft Ads, and the Trade Desk are listed. When the administrator selects one or more of them, for example, Google Ads and Microsoft Ads in the example shown in FIG. 5A, the selected platforms will show up in the block 504. In the block 504, a dropdown list 506 corresponding to each selected platform is shown allowing the administrator to choose one or more accounts under the selected digital marketing platform. The administrator may select from the dropdown list 506 the user accounts of which the administrator wants to add or edit accessibilities. The administrator may keep choosing the digital marketing platform of which the user accessibilities is to be edited. In the example shown in FIG. 5A, Microsoft Ads is also selected and a corresponding dropdown list 506 is shown for the administrator to select one or more accounts under which the administrator wants to add or edit accessibilities of the users. Once the administrator has selected one or more digital marketing platforms and one or more accounts in each selected digital marketing platform and proceeds by, for example, clicking on the “Link Account” button, the user interface 500 will then allow the administrator to select the users that are granted accessibility of the respective accounts.

FIG. 5B shows an example of the user interface 520 when the administrator may edit a list of users that may access a specific platform account. In the example shown in FIG. 5B, the administrator has selected two accounts of Google Ads and one account of Microsoft Ads. As shown in FIG. 5B, the administrator may then edit the list of users that are granted accessibility of the corresponding account. The administrator may also add a user to the accessibility list by clicking on the button of “Assign Users” or remove a user from the accessibility list by checking the user and remove as prompted by the user interface.

FIGS. 5A and 5B are examples of how an administrator changes the accessibility of the users to the respective accounts on the digital marketing platforms. In another embodiment, an administrator may also select a user first and then grant the access of the accounts.

In another embodiment, the users in the same client group may further include one or more user groups as subgroups of the client group. The users may be categorized into the subgroups based on various authorization and accessibility on the functions of the digital marketing management system and settings and content of media plan, campaign, advertisement group, and advertisement. As an example, the one or more user groups may comprise a user group that is authorized to draft the settings of media plans, campaigns, advertisement group, and/or advertisement, and a supervising user group that approves the draft of the settings before those settings are finally submitted to the corresponding digital marketing platforms, which will be described in detail below concerning user approval.

Media Planning and Campaign Automation

Below, the media planning and campaign automation module 420 will be described by referring to FIGS. 4 and 6-9. A campaign is a set of one or more advertisements, including but not limited to visual advertisements, video advertisements, contextual advertisements, keywords, and bids, that share a budget, location targeting, audience targeting, and/or other settings. Most of the digital marketing platforms, such as, Google Ads and Facebook Ads, use “campaign” to refer to such set of one or more advertisements under one account so that their clients may manage this set of advertisements as the same group, for example, under the same budget, for the same goal, for the same intended audience, etc. Therefore, unless otherwise specified, a campaign in the present digital marketing management system refers to a campaign set up under an account at a specific digital marketing platform. Most of the digital marketing platforms also allow their users to further divide the advertisements in the same campaign into a few subgroups which are usually called advertisement group, Ads Group, or Ads Set to manage the advertisement settings in subgroups.

In many cases, however, a user may want to manage a media plan covering campaigns with the advertisements to be posted on multiple digital marketing platforms. The digital marketing management system in this embodiment allows users to plan and manage a comprehensive media plan architecture across digital marketing platforms through the media planning and campaign automation module 420.

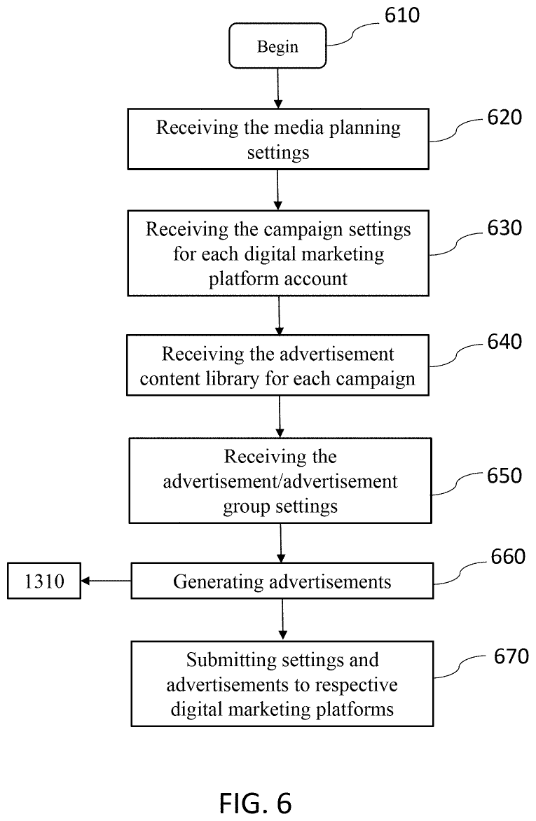

FIG. 6 is a flow chart of the media planning and campaign automation routine according to one embodiment of the present invention. The media planning and campaign automation routine begins at step 610, when the user selects to add or edit a media plan.

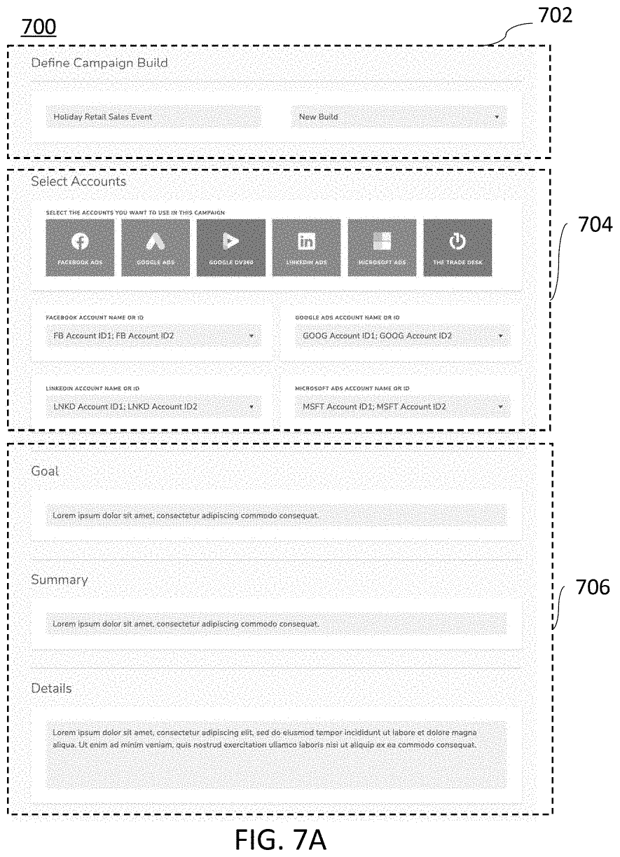

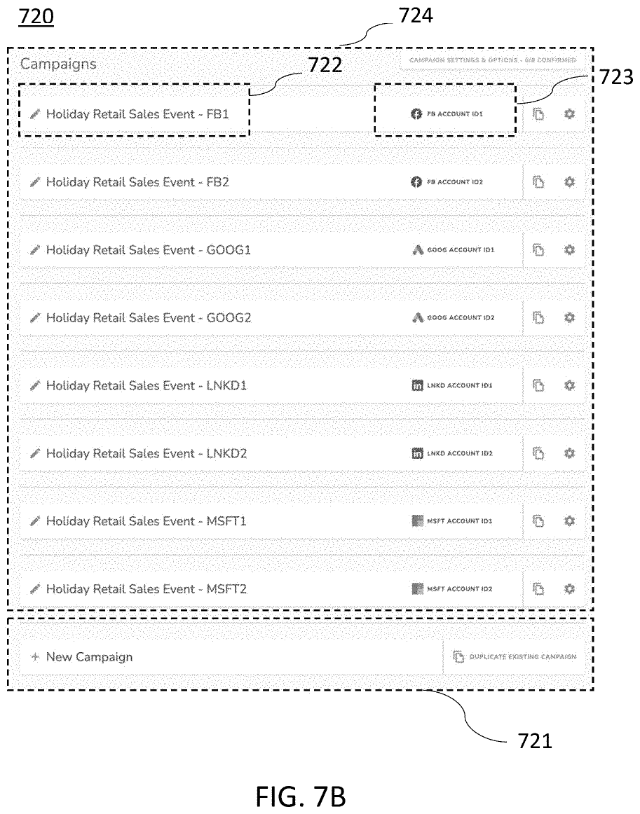

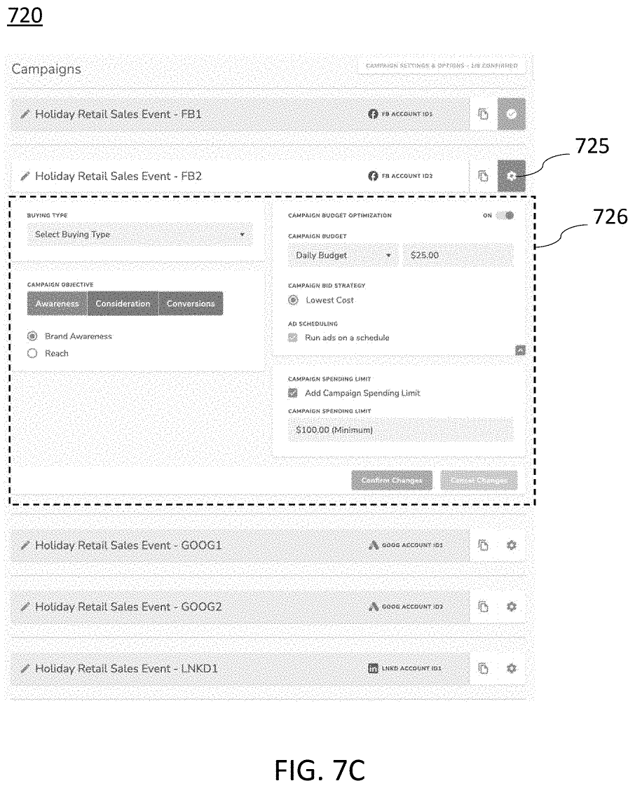

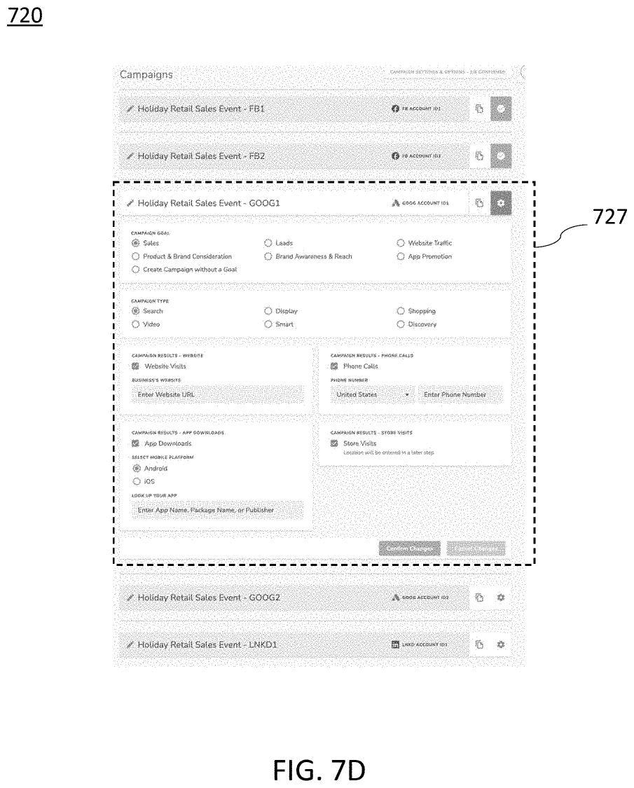

Next, the digital marketing system 420 receives from the user the media planning settings at step 620. Items that can be set for the media planning across one more digital marketing platforms may include a media plan name, one or more digital marketing platforms and one or more accounts in each selected digital marketing platform that the user wants to use in the media plan. In some embodiments, the user may also be allowed to set overall budget, notes describing the goal, summary and other information about the media plan, and so on. FIG. 7A illustrates an exemplary user interface 700 for receiving the media planning settings. As shown in FIG. 7A, a user may input a media plan name in the input box shown in the block 702, select each digital marketing platform and each account that the user wants to use in the media plan in the block 704, and input optional notes in the input boxes shown in the block 706. In the example shown in FIG. 7A, the media plan name is “Holiday Retail Sale Event”, and two accounts at Facebook Ads, two accounts at Google Ads, and two accounts at Microsoft Ads are selected to post the sets of advertisements, that is, the campaigns.

Next, at step 630, the settings of each campaign at each selected account of each selected digital marketing platform are received from the user. Items that can be set for the campaign largely depend on the API (that is, Application Programming Interface) of the corresponding digital marketing platform. Usually, the settings may include a campaign name that may be common to all digital marketing platforms. FIG. 7B illustrates an exemplary user interface 720 for receiving campaign settings, more specifically, the campaign names for each selected digital marketing platform and account. As shown in FIG. 7B, the user may click “+New Campaign” button in the block 721 to add a campaign and then choose one of the accounts selected at step 610 and input the campaign name. The block 724 shows the campaign names, as indicated by the block 722, that have been input corresponding to the selected account, as indicated by the block 723. The digital marketing platforms usually also require other settings for campaigns, such as, goals, budget, bid strategy, and so on. The media planning and campaign automation routine will adjust the information needed on the user interface based on the requirement of the corresponding platforms.

FIGS. 7C and 7D illustrate a part of the exemplary user interface 720 for further receiving the settings for campaigns that are specifically required by each selected digital marketing platform account. As shown in FIG. 7C, when the user clicks on the setting button 725 in the same row of campaign name, a drop-down area 726 will show up for receiving campaign settings. Since the corresponding campaign is a campaign at Facebook Ads, the items that can be set are defined by Facebook Ads, and in this case include the buying type, campaign objective, and optional campaign budget optimization. As shown in FIG. 7C, the campaign objective may be at least one of brand awareness (for example, intended views of the advertisements), consideration (for example, intended consumer engagement such as clicks), and conversion (for example, intended consumer conversion such as visits to a website, app downloads, purchases, and phone calls). This will be translated to the goal of the campaign by the digital marketing platform (in this example, Facebook Ads) to optimize how and when the advertisement will be delivered to the target consumer to maximize the efficiency in term of the set goal based on its algorithm. For example, if the optimization is set for link clicks (a type of conversion), the platform will target the advertisements to persons in the audience who are most likely to click the link in the advertisement; and more budget will be allocated to one or more of the advertisements that are getting more link clicks. FIG. 7D is an example of the settings of a campaign at Google Ads in the exemplary user interface 720. The campaign settings at Google Ads similarly include campaign objective, shown as campaign goal in the area 727, and other settings that are specifically required by Google Ads, such as campaign type and campaign result. Those campaign settings depend on the API of the corresponding digital marketing platform and can be updated when a digital marketing platform changes its settings and API. The users of the digital marketing management system 400 may thus add, change, and manage campaigns across various digital marketing platforms and multiple accounts in a same digital marketing platform at one place without having to log into respective platforms.

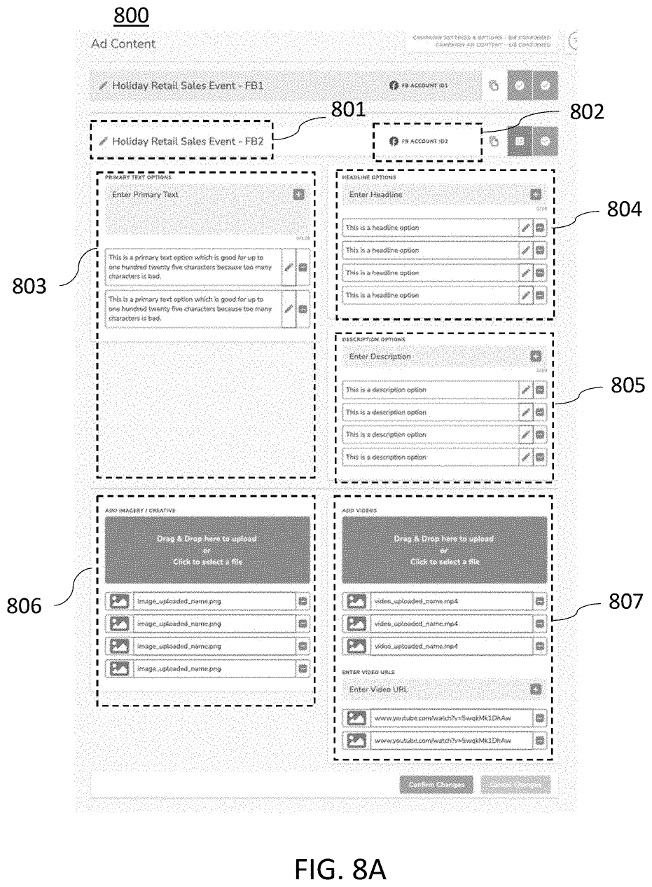

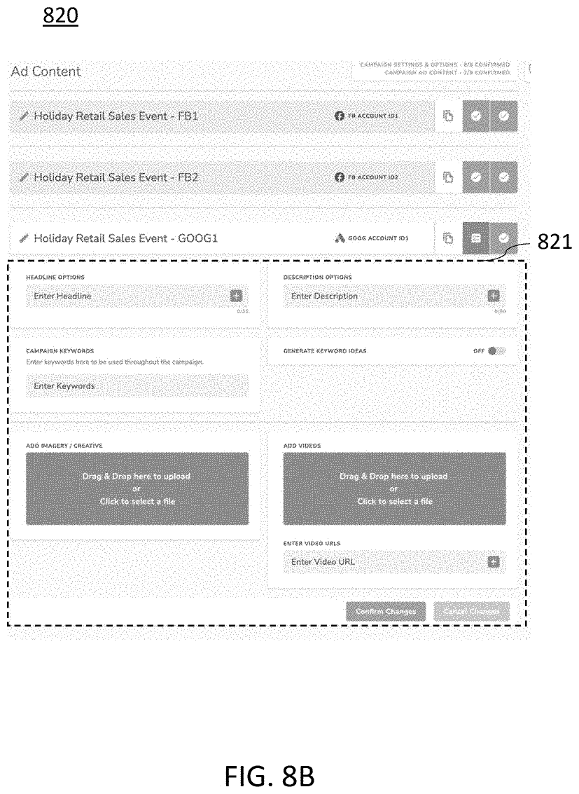

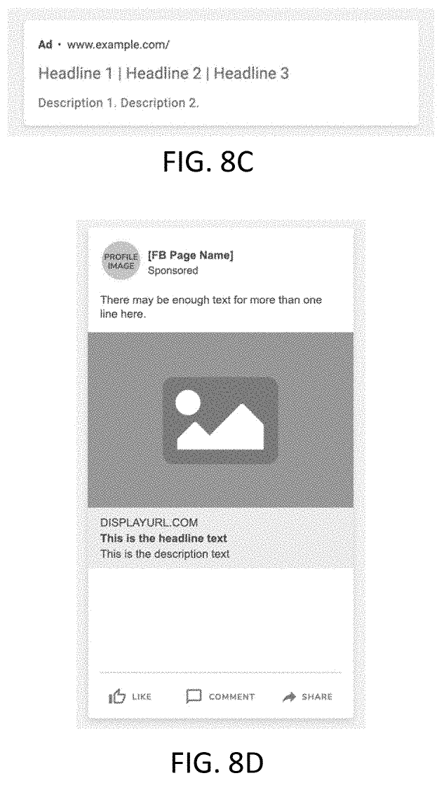

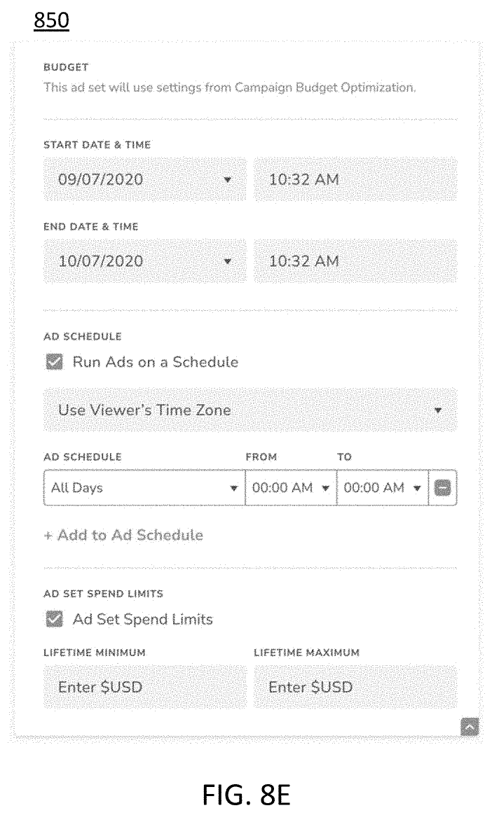

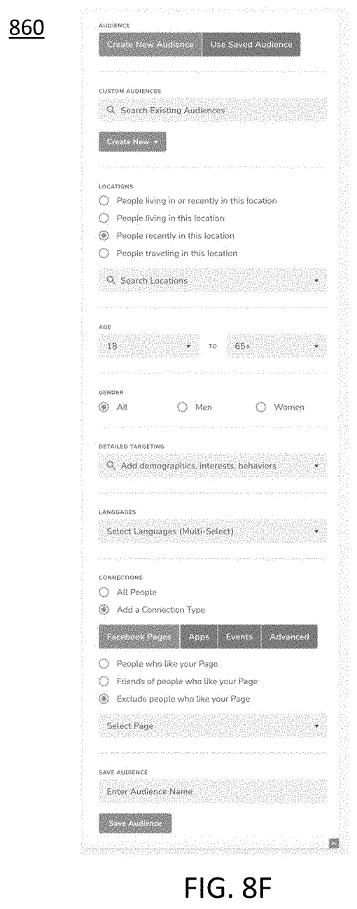

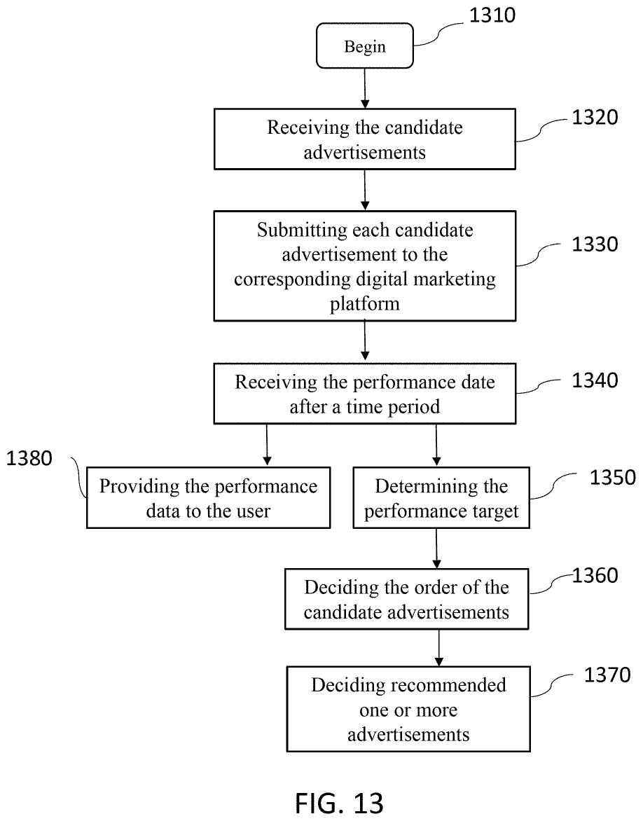

Next, at step 640, the content library for each campaign is received from the user. The elements required to constitute an advertisement depends on the advertisement type and the standards or requirements of the respective digital marketing platforms. For example, the advertisement type may include keyword search, display, banner, etc., while the elements constituting a corresponding type of advertisement may comprise headline, image, video, description for a display advertisement; keyword and target uniform resource locator (“URL”) for a keyword search advertisement; and banner image and on-error description (which will be shown when the banner image has not been downloaded successfully on a consumer device) for a banner advertisement. For example, FIG. 8C illustrates an exemplary keyword search advertisement on Google Ads. The customizable information may include a group of keywords, the headline and description shown on the search result page, and the target uniform resource locator (“URL”) of the advertisement. FIG. 8D illustrates an exemplary display advertisement on Facebook Ads. The customizable information may include the primary text, headline text, description text, picture or video, and target URL. The media planning and campaign automation module 420 according to the present embodiment allows the user to input all these items of advertisement content, including but not limited to headlines, images, videos, keywords, URLs for each campaign, among the others, as a content library. The media planning and campaign automation module 420 may then automatically generate optional advertisements based on the standards of the respective digital marketing platforms. The user may in turn choose one or more of them as the finalized one or more advertisements to be published or further edit and adjust the items of the content to form the finalized ones. In another embodiment, the user may also have some or all of the optional advertisements to run on the platform to test their performance. In this case, as shown in FIG. 6, the routine will jump to step 1310, to start automated decision maker routine, which will be described in detail below by referring to FIG. 13.

FIG. 8A illustrates an exemplary user interface 800 to add and edit a content library for a campaign under a Facebook Ads account. As shown in FIG. 8A, the exemplary content library is designed for the specific campaign 801 under a specific digital market platform account 802 (in this example, a Facebook Ads account). The content library includes a first block 803 for optional primary text, a second block 804 for optional headline text, a third block 805 for optional description, a fourth block 806 for optional images, and a fifth block 807 for uploading optional video clips or inputting optional video URLs. In each block, the user may add a new entry of an element and may view, edit and delete an entry of element. For example, in the first block 803, two optional primary texts are added. The user may add more optional primary text by clicking the “+” button. The user may also edit or delete an existing optional primary text by clicking a corresponding edit or delete button. In one embodiment, the number of element entries that the user may add is capped at a predetermined account. In another embodiment, the user may be allowed to add unlimited number of element entries.

FIG. 8B illustrates another exemplary user interface 820 to add and edit a content library for a campaign under a Google Ads account. As shown in FIG. 8B, the block 821 include blocks for adding, editing, and displaying advertisement content elements that are tailored according standards of Google Ads. The types of elements may similarly include headline text, image, and video and further include keyword. The user is allowed to input optional keywords. In one embodiment, the media planning and campaign automation module 420 may also generate keywords for the user. When the user chooses to generate keywords by the media planning and campaign automation module 420, the module 420 will ask the user for information such as the target URL, the name and description of the product to be promoted, the related trademark, etc., and generate recommended keywords through, for example, artificial intelligence association or predetermined rules (for example, words from the product name and URL and word combination thereof). The user may then select one or more recommended keywords to add to the content library.

When an advertisement is to be generated, the media planning and campaign automation module 420 may automatically choose element entries from the content library corresponding to the campaign based on advertisement type, and generates optional advertisements based on the standards of the digital marketing platform. The user may then choose from or edit the optional advertisements to generate finalized advertisements or choose candidate advertisements to run on the platform to test their actual performance. This will be discussed in detail below.

As may be understood by those in the art, the types of elements that the user may add to the content library depend on the standards set by the corresponding digital market platform. In one embodiment, the elements and corresponding blocks on the user interface for editing and displaying element entries are manually set based on the standards of the respective digital marketing platforms. In another embodiment, the Media Planning and Campaign Automation module may read and analyze standards or API description of the respective digital marketing platforms and automatically set the elements and corresponding UI blocks.

Next, at step 650, the settings of each advertisement or each advertisement group are received from the user. As aforementioned, further dividing advertisements in a campaign into advertisement groups may provide some benefits in managing the campaigns, since some of the advertisements may share the same settings. The settings at this step may be also referred to as advertisement group settings, or Ads group settings. Many digital marketing platforms provides the advertisement group in their API. An advertisement group contains one or more advertisements that share similar or same settings, such as object, budget, bidding strategy, target audience, advertisement type, among the others. For example, the digital marketing platforms usually allow the user to set a bid or price to be used when an advertisement in an advertisement group is triggered to appear (for example, by keyword search). In addition, the advertisement groups may be used to organize the advertisements by a common theme, such as the types of products or services the user wants to promote. Items that can be set for the advertisement also largely depend on the API of the corresponding digital marketing platform. As an example, the settings can be categorized into budget settings, target audience settings, placement settings, and optimization for advertisement delivery settings. In this example, optimization for advertisement delivery refers to optimization and goal as described by referring to FIGS. 7A and 7B.

For example, FIG. 8E illustrates an exemplary user interface 850 for receiving budget settings for the advertisement settings. As shown in FIG. 8E, items can be set for advertisement budget may comprise the schedule for running the advertisement and the spend limit for the advertisement. The schedule may be set with a start date and time and an end date and time. An additional daily schedule based on time zone may be set too. FIG. 8F illustrates an exemplary user interface 860 for receiving target audience settings. As shown in FIG. 8F, the target audience settings may include location, age, language, interests, connections with other audience, behaviors and other demographics. The placement settings allow the user to choose networks and placements the advertisement may be shown. For example, for Facebook Ads account, the user may select networks from Facebook, Instagram, and Messenger for the advertisement to be displayed. The user may further select from Facebook news feed, Facebook marketplace, Facebook video feeds, etc. for the placement of the advertisements. The user interface and the settings aforementioned are just examples, and the items that can be set for the advertisement may be more or less depending on the user's need and the API of the corresponding digital marketing platform. For example, the user may be further allowed to set daily, weekly, or monthly schedules on which the advertisement is run. For example, the user may set to include or exclude target locations based on countries, states, and/or cities in which the audience is currently located, is regularly located, or shows interested. For example, the user may set target audience based on additional audience demographics, such as, parental status, marital status, and so on. In some embodiments, the user may be allowed to set bidding strategy and conversion specific to the advertisement in addition to those inherited from the campaign settings and sub-campaign settings. Similar to sub-campaign settings, most of the advertisement settings may be optional depending on the API of a specific digital marketing platform.

The routine then goes to step 660 to generate one or more advertisements. As aforementioned, the media planning and campaign automation module 420 may automatically select elements, and one or more entries of each selected element from the content library, and generates optional advertisements based on the corresponding standard of the digital marketing platform. For example, when the user has input the content library for the campaign 801 under Facebook Ads account 802, the module 420 may automatically generate, as an example, one or more video display advertisements each comprising of one selected primary text, one selected headline text, one selected video or video URL, one selected description. In one embodiment, the selection may be done manually by the user. In another embodiment, the selection is done automatically by the module 420. In this case, the module 420 may select the element entries in each element category required by the standards of the digital marketing platform in a random way (for example, all or some of the permutations of entries) or based on rules (for example, in the order of the items that are added, or based on the language of the text, or base on all possible combinations). The module 420 will then show the generated optional advertisements for the users to choose or edit. The user may choose one or more advertisements as finalized advertisements to be submitted to the corresponding digital platform. The user may also edit a generated optional advertisement by substituting one or more elements with those the user manually selects from the content library.

In many cases, the user may be not sure which one of the optional advertisements is better to achieve the object of the media plan. The routine may optionally jump to automated decision maker module 450 (step 1310 shown in FIG. 13) to help the user decide which one or more advertisements to choose, which will be described in detail below by referring to FIG. 13.

Optionally, at step 660, the user may also choose to add one or more advertisements to the respective advertisement groups if there are multiple advertisement groups set up in a campaign at step 650.

The routine then goes to step 670, in which the settings and corresponding advertisements are submitted to each designated digital marketing platform through its API.

In other embodiments, the order of the steps in the media planning and campaign automation routine is not limited to that shown by FIG. 6 and may be changed as needed, and some of the steps may be omitted. For example, the media planning and campaign automation routine may receive the campaign settings from the user before receiving the media planning settings. The media planning and campaign automation routine may receive the campaign settings before adding the campaign under an existing media plan or receive the advertisement content library and generate the advertisement before adding the advertisement under an existing campaign or an existing advertisement group. In another example, when the user intends to edit an existing media plan without changing the campaign settings or advertisement settings and content, only step 620 may be performed.

In some other embodiments, the media planning and campaign automation routine may also comprise a step of retrieving the settings of an existing campaign and its corresponding advertisement settings and content. The media planning and campaign automation routine may further include steps allowing the user to add the retrieved campaign and its corresponding advertisement to be under a designated media plan.

In further another embodiment, the media planning and campaign automation routine does not require the user to set up a content library. The media planning and campaign automation routine may receive the content of one or more advertisements that the user has already predetermined in lieu of steps 640 and 660.

Optionally, an additional approval step may be added to the flowchart as shown in FIG. 6, when a supervising user group is set up in the user management. When a user adds or edits any of the settings of a media plan, settings of a campaign, advertisement content library, settings of advertisement or advertisement group, or a generated advertisement at the steps 620-660, the media Planning and campaign automation module 420 may further send the settings or generated advertisement(s) to a designated supervising user or supervising user group. The supervising user or supervising user group has been granted the authority though the user management module 415 to approve before these settings and generated advertisement(s) are submitted and posted to the respective digital marketing platforms. In one embodiment, only one approval step is set before the step 670. A positive result of the approval step will make the routine proceed to step 670; otherwise, the routine will go back to step 610. In another embodiment, each or at least one of the steps 620-660 is followed by an approval step, a positive result of an approval step will make the routine proceed to the next step; otherwise, the routine will go back to the corresponding step.

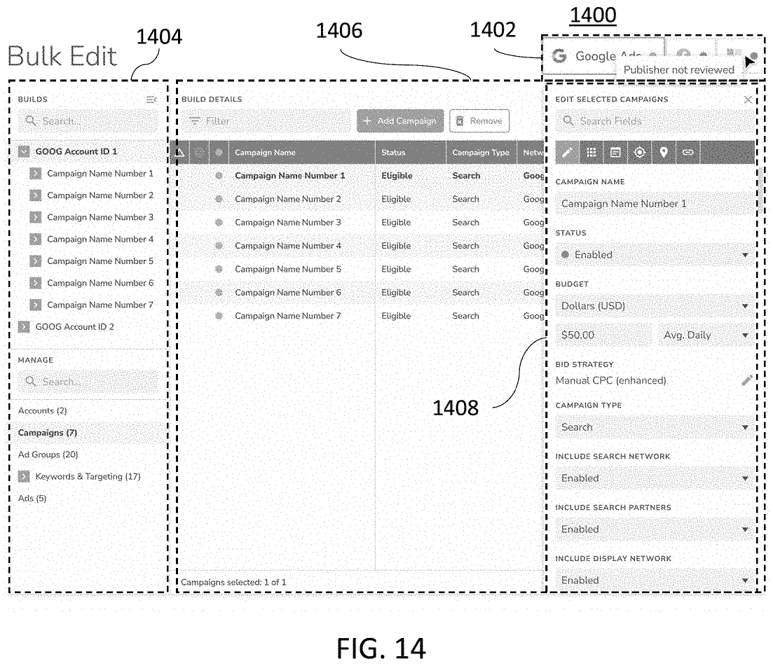

Additionally or alternatively, the media planning and campaign automation module 420 may allow a user to edit or upload settings of media plan all together, including the campaign settings, advertisement group settings, and advertisement settings. FIG. 14 illustrates an exemplary user interface 1400 enabling a user to make a bulk edit on a media plan. As shown in FIG. 14, the platforms that the media plan is using are listed as tabs in the area 1402. In this example, the tabs include Google Ads and Facebook Ads. The user may add more platforms to the media plan. The user may edit settings related to a specific platform by choosing the corresponding tab in the area 1402. Once a specific platform is chosen, related platform accounts, campaigns, advertisement groups and advertisements are listed in their hierarchy in the area 1404 in a drop-down manner. For example, if the user clicks “Goog account ID 1,” all its campaigns will show up thereunder. If the user further clicks one of the campaigns, the related advertisement groups will show up. When a specific item is selected in the area 1404, the user may then view and edit the settings in the area 1406. In the example shown in FIG. 14, when a Google Ads account “Goog Account ID 1” is selected, the user may view and edit its account settings in the area 1406, including campaign name, status, campaign type, among others. The user may also add a new campaign by simply clicking the “+.” When the user selects a specific campaign from the area 1404 or 1406, a pop-up window may be presented in the area 1408 for user to edit the campaign settings. Likewise, when the user selects an advertisement group or an advertisement, the corresponding settings may be present to the user in the area 1406 or 1408. By providing the user interface for bulk edit, a user may add, edit, or remove the media plan settings at one stop. The arrangement of the user interface as shown in FIG. 14 is an example for bulk edit. Other elements than dropdown listings, pop-up windows and other arrangement of these elements may be used.

In addition to the bulk edit, or alternatively, the media planning and campaign automation module 420 may allow the user to upload a data sheet containing a part or all of the settings related to a media plan and create or update the media plan in the digital marketing management system. The data sheet may be in a form that is machine readable, such as, text (txt), Comma-separated Values (CSV), spread sheet such as Microsoft Excel and Apple Numbers, Cascading Style Sheets (CSS), among others. In one embodiment, the media planning and campaign automation module 420 may provide the user with an exemplary data sheet including the exemplary settings, and the user may fill out a data sheet based on the exemplary data sheet.

Performance Analysis and Metrics Customization

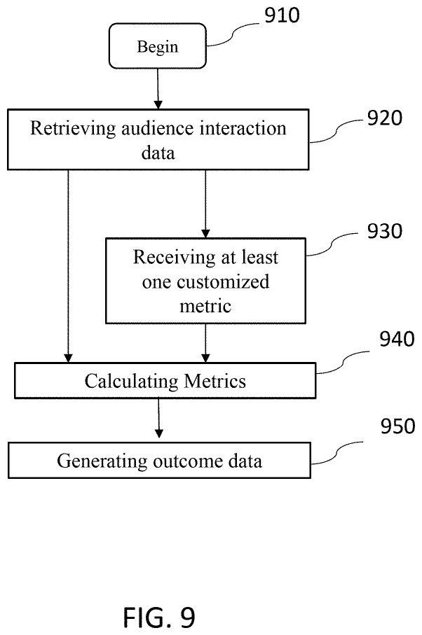

Below, the performance analysis module 430 and metrics customization module 440 will be discussed by referring to FIGS. 4 and 9. FIG. 9 is a flow chart of the performance analysis routine according to an embodiment of the invention. As shown in FIG. 4, in one embodiment, the metrics customization module 440 may be a submodule of the performance analysis module 430, which may be performed only when needed.

As shown in FIG. 7, the performance analysis routine begins at step 910. After the user has authorized the accessibility of at least one account of at least one digital marketing platform, the digital marketing management system may run the performance analysis routine at a preset time interval. The performance analysis routine may also begin upon the user's request by, for example, refreshing from the user's terminal device.

At step 920, the consumer interaction data describing an effect of consumer interaction with each advertisement is received from each authorized digital marketing platform. The detailed parameters included in the consumer interaction data vary among the digital marketing platforms, but usually comprise at least one from the group consisting of impressions, clicks, impression share, views, view rate, phone calls, interaction rate, cost, cost per interaction (CPI), cost per click (CPC), click through rate (CTR), conversion, conversion rate, and optimization score. Below the definitions of these exemplary parameters are listed:

Impressions: the count of how often an advertisement has appeared on a search results page or website through the digital marketing platform;

Impression share: the impressions of the advertisement divided by all the available impressions through the digital marketing platform;

Clicks: the count of clicks the target link of an advertisement has been clicked;

Cost: the sum of costs charged by the digital marketing platform related to the advertisement for a period of time;

Interaction: the number of interactions. An interaction is the main user action associated with an advertisement type: clicks for text and shopping advertisements, views for video advertisement, and so on;

Interaction rate: How often consumer interact with an advertisement after it is shown to them. This is the number of interactions divided by the number of times the advertisement is shown;

Views: the number of times a video advertisement were viewed;

Phone calls: the number of offline phone calls;

CPI: Cost per interaction, the average amount paid per interaction of the consumer, wherein the interaction varies by campaign and advertisement type. Interactions may include clicks, video views, or engagements;

CPC: Cost per click, the average amount paid per click of the consumer;

CPV: Cost per view, the bidding cost of each view by the consumer for the advertisement;

CTR: Click through rate, which measures the number of clicks advertisers receive on their advertisement per number of impressions;

Conversion: The number of conversions for all conversion actions that have been opted into optimization;

Conversion rate: The number of conversions divided by total clicks that can be tracked to conversions; and

Optimization score: Optimization score is calculated based on how well the account is set to perform across search, display and shopping.

Next, at step 940, the metrics are calculated based on the parameters in the retrieved data. In one embodiment, the metrics may include one or more metrics that are the parameters themselves included in the consumer interaction data received from a digital marketing platform. For example, the metrics may include interaction rate which is provided by at least one digital marketing platform, for example, Google Ads. If another digital marketing platform does not provide interaction rate in the user interaction data but still provides number of interactions and the number of times the advertisement is shown, the metric of interaction rate may be calculated by the number of interactions divided by the number of times the advertisement is shown.

In another embodiment, the metrics may comprise at least one preset metric which is calculated based on a preset formula of parameters in the user interaction data. For example, a preset metric may be an index metric that is commonly used in the industry, so that a user can simply select to use it without manually inputting a customized metric (which will be described later). Alternatively, or in addition, the digital marketing management system 400 may also include a routine to catch a customized metric that has been frequently used by the user and make the customized metric a preset metric for the particular user, or, if the user is an entity user or an individual user under an entity user, the other users under the same entity user. With the consent of the user, the digital marketing management system 400 may also make the metric a preset metric globally for any user of the system. For example, the metrics may include a preset metric named as Campaign Spend, which is the sum of all the Costs for the same overall campaign across the digital marketing platforms in total. For example, if the user interaction data includes the number of clicks (Clicks) on the target URL made by the consumer and an overall cost (Cost) charged on the clicks, the metrics may include a preset metric Cost Per Click, which equals to Cost/Clicks. If the user interaction data includes the number of views (Views) of consumer on the advertisement and an overall cost (Cost) charged on the views, the metrics may include a preset metric Cost Per view, which equals to Cost/Views. If the user interaction data includes the number of interactions (Interactions) of consumer and an overall cost (Cost) charged on the interactions, the metrics may include a preset metric Cost Per Interaction, which equals to Cost/Interactions. If the user interaction data includes the number of conversions (Conversions) such as intended purchases or phone calls, made by consumer through the advertisement and the number of clicks on the target URL through the advertisement (Clicks), the metrics may include a preset metric Conversion Rate, which equals to Conversions/Clicks. If Conversions per 1,000 impressions is of interest, it can be set as a preset metric, which equals to Click through rate times Conversion rate further times 1,000.

In further another embodiment, the at least one preset metric may comprise a conditional metric that is calculated by a formula including logic operation. The value of the conditional metric, that is, true or false, may then be used as a trigger for an action that can be selected by the user, such as, sending an alert, changing budget settings, making an advertisement inactive, among others. Below, an example of a preset conditional metric is provided.

### Example I

([impressions_last_day]>25000 AND [impressions_last_day wow]>0 AND(([impressions_last_day]/[impressions_last_day wow]−1)>0.35)AND((([cost_last_week]/[cost_7_days_wow])−1)<((([impressions_last_day]/[impressions_last_day wow])−1)*0.7)OR ((([cost_last_week]/[cost_7_days_wow])−1)>((([impressions_last_day]/[impressions_last_day wow])−1)*1.5)))) (I)

In formula I, “impressions_last_day refers to the number of impressions over the last day; “impressions_last_day wow” refers to the number of impressions for the previous day one week prior; ([impressions_last_day]/[impressions_last_day wow]-1) thus refers to a week-on-week growth of the number of impressions on last day compared with the same day in the prior week; “cost_last_week” refers to the cost over the last week; and “cost_last_week wow” refers to the cost over a week one week prior”; and (([cost_last_week]/[cost_7_days_wow])−1) thus refers to a week-on-week growth of the weekly cost. The formula I is an example of a formula that returns a value of “True” or “False”, which represents a condition that may be of a particular interest of the users of the digital market management system.

Optionally, as shown by FIG. 9, the routine may further comprise a step 930, in which at least one customized metric is received from the user. Specifically, the user may set name, description, and formula of a customized metric and add it to the list of the metrics that are to be calculated at the step 940. The variables of the customized metrics may be selected from the parameters of the consumer interaction data and the other metrics, campaign settings, advertisement settings, date, time, and so on. In addition, the formula may include logic operations such as “and,” “or,” “>” and “<.” In one embodiment, the digital marketing management system 400 may allow user to type the formula. In another embodiment, the digital marketing management system 400 may visually show the optional variables and operations as buttons, input boxes, or drop-down lists, and allow the user to drag the selected variables and operations to form the formula. In another embodiment, the digital marketing management 400 may also allow the user to load a preset metric and modify it into a customized metric by, for example, changing a parameter, adjusting a value of a constant, adding or removing an operator, among others.

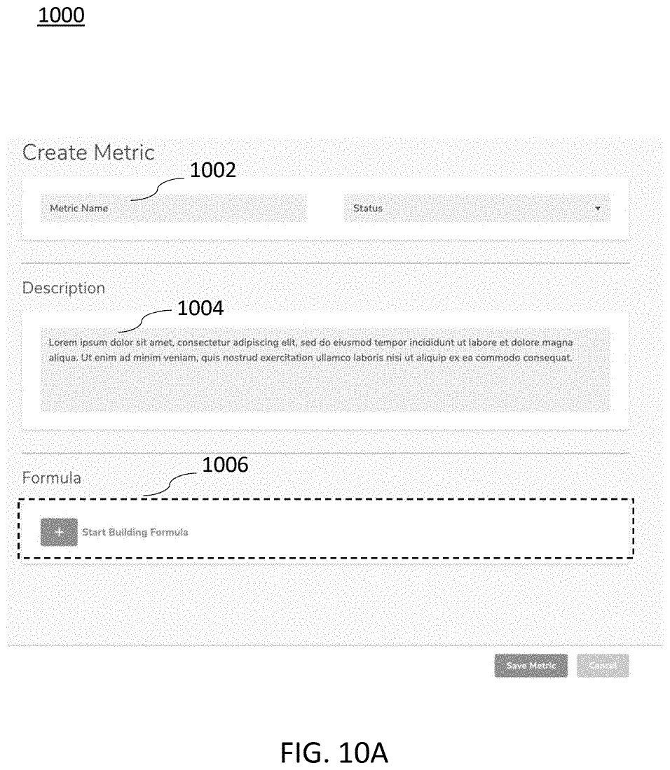

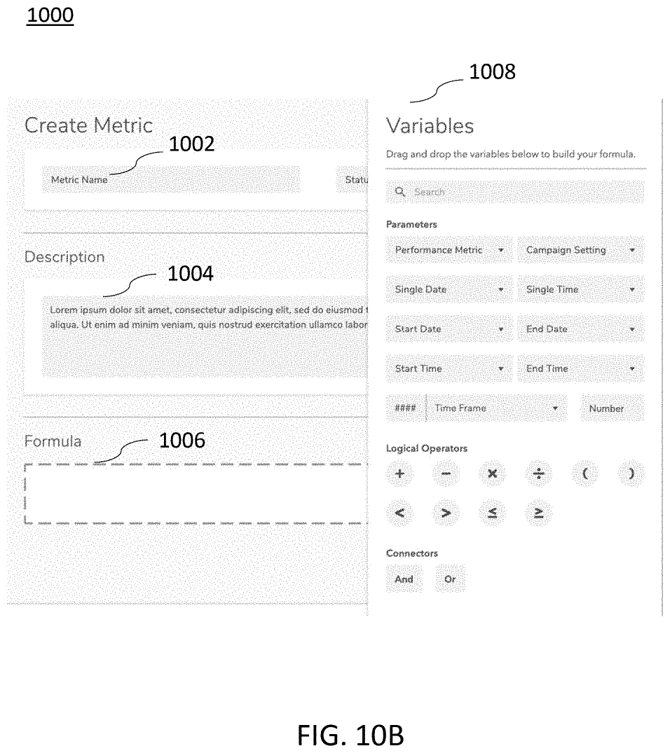

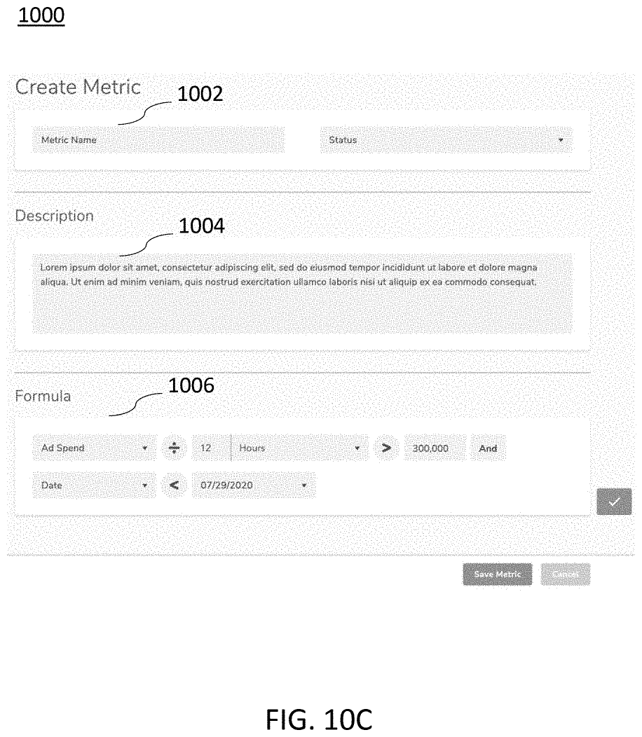

FIGS. 10A-10C illustrate an exemplary user interface 1000 showing the addition and edition of a customized metric according to one embodiment of the present invention. As shown in FIG. 10A, the user interface 1000 comprises a text box 1002 for inputting the metric name, a text box 1004 for inputting description or notes about the metric name, and an area 1006 for editing the formula for the customized metric. When the user clicks on the “+” button in the area 1006, a popup menu 1008 will show up as shown in FIG. 10B. The popup menu 1008 provides a visual editor for the metric's formula. The popup menu 1008 comprises parameters or variables that are categorized and presented as multiple drop-down boxes or input boxes, and operators including arithmetical operators such as “+,” “-,” “x,” “I,” and logic operators such as “>,” “<,” “and,”, and “or.” The user may drag the variables and operators into the area 1006, select the specific variables in the drop-down box if any, and arrange them into a formula. For example, if there is a number 300,000 in the formula, the user may drag the input box named “Number” into the area 1006 and input 300,000 in the input box. If the formula contains a variable “AdSpend” which is categorized under “Performance Metric” and refers to the cost of an advertisement, the user may select the drop-down box “Performance Metrics” and select the variable “AdSpend.” An exemplary formula that is thus formed in the area 1006 is thus shown in FIG. 10C.

### Example II

Formula I is an example of customized metric that may be added or edited by the user: AdSpend>300,000 and Date<07/29/2020 . . . (II)

In this example, the Formula II will return logical result, which is “True” when the overall cost of the advertisements goes beyond $300,000 before Jul. 29, 2020. In any other case, the result will return “False.” The user may choose to view the result of the metric, use the result of the metric as parameter of another metric, or use the metric as a trigger of other actions, such as, sending an alert, or being used in the automated decision maker.

Output and Alert

In one embodiment, the digital marketing management system 400 generates outcome data based on the consumer interaction data and the metrics to be output to the user.

The digital marketing management system 400 may then show the result based on the outcome data to the user.

In one embodiment, the result may be shown to the user in a dashboard like manner on the user terminal such as a computer, smart phone, tablet, or tv. For example, the value of a variable or parameter in the user interaction data, or a metric calculated based on the user interaction data, and so on may be shown to the user in numbers. The change of the value of the parameter or the metric over time may be shown in a curve graph.

For example, the dashboard showing the outcome data may include an overview of the media plan synthetically showing the overall performance across all the platforms on which campaigns under the same media plan are running. The outcome data may include an overall cost, overall conversions, overall conversion rate, or a customizable metric by calculating the performance data received from all the platforms. For example, an overall cost that is a sum of the cost of all campaigns across platforms can be shown with a number, or a curve of the number over time. An overall conversion rate can be the total number of conversions across all the platforms divided by total clicks that can be tracked to conversions.

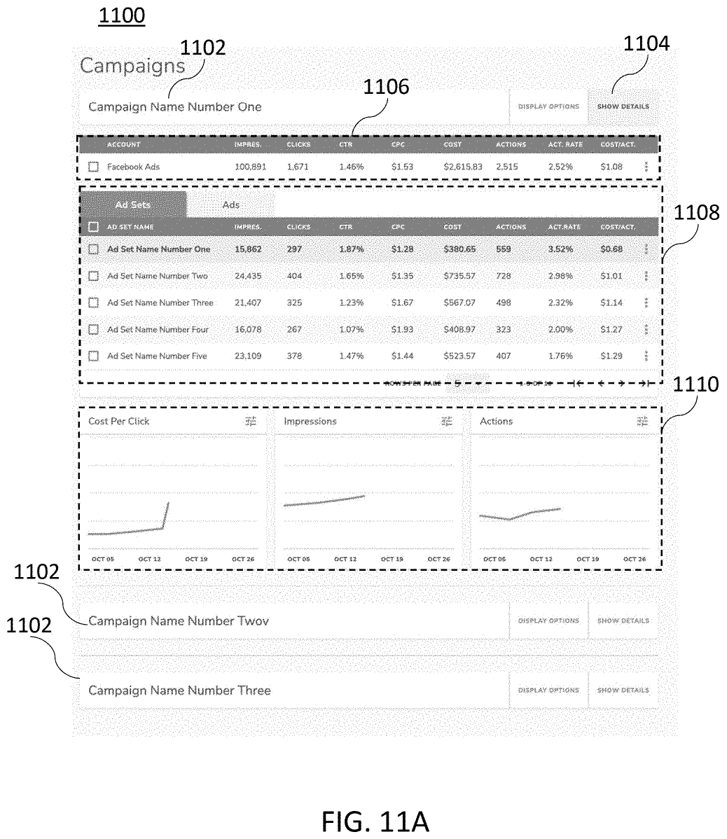

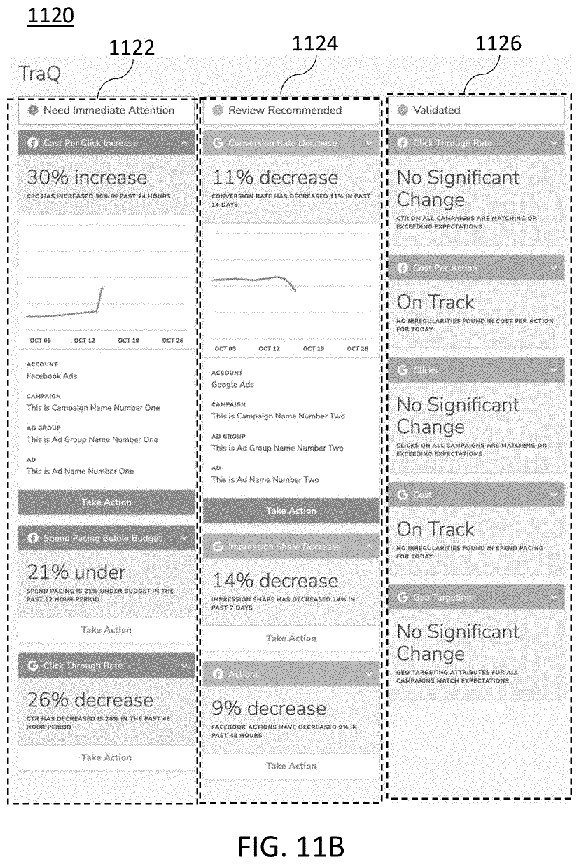

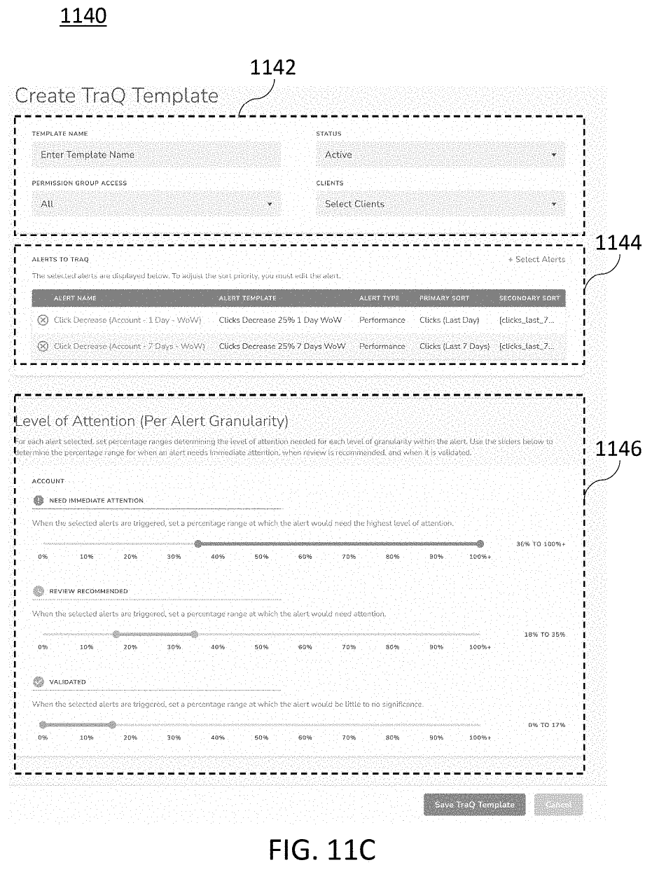

In another embodiment, the dashboard showing the outcome data may further include an overview of the data corresponding to the respective campaigns and respective platform account. FIG. 11A illustrates an exemplary user interface 1100 showing the outcome results on a campaign-to-campaign basis. As shown in FIG. 11A, the user interface 1100 shows to the user the performance of all campaigns under the same media plan. The blocks 1102 are the campaign names. When the user clicks the button 1104, more details will show up below the campaign name. In this example, an overall performance of the campaign, performance of each advertisement group and advertisement are shown in the blocks 1106 and 1108, respectively. The performance data of the campaign is shown in the block 1106, for example, including the platform name where the campaign is being run, impressions, clicks, cost, among the others. In the block 1108, the performance data of each of the advertisement group and each of the advertisement are shown in two respective tabs. The example of FIG. 11A illustrates the performance data of the advertisement groups (Ad Sets in FIG. 11C) in a table, which similarly includes, for example, impressions, clicks, cost, among the others. In the block 1110, the performance data and metrics are visualized and shown in a curve graph illustrating their changes over time. In the example shown in FIG. 11A, Cost per Click, Impressions and Actions are shown in the area 1110. However, in other embodiments, other performance data and metrics can be predetermined or selected by the user. The user may also choose one or more customizable metrics to be shown in a curve graph in the area 1106.

In addition, the numbers and graphs may be categorized based on their priorities. For example, those that require immediate attention of the user may be shown in a specific color such as red, or with a specific mark.

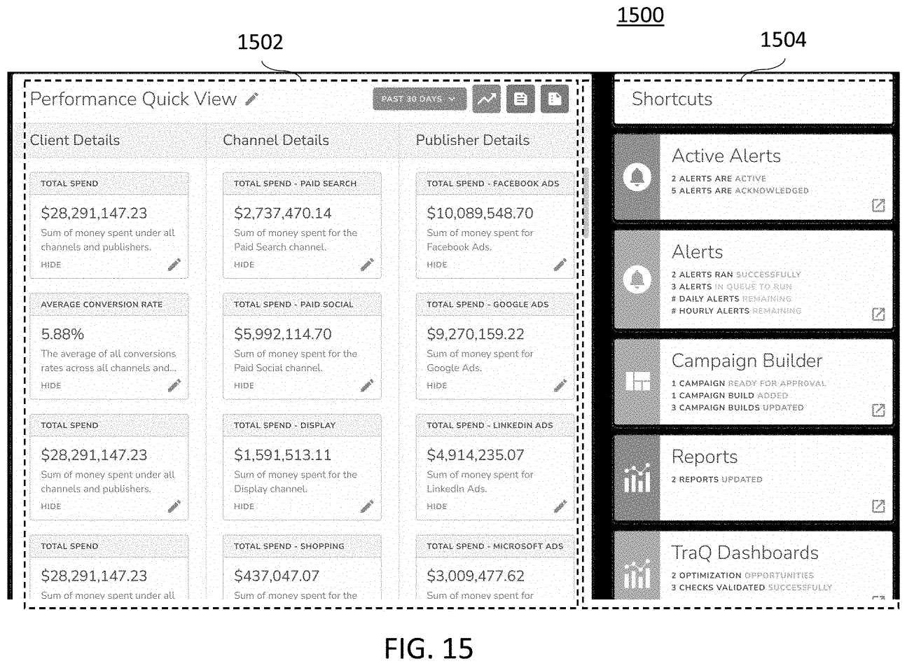

FIG. 15 illustrates another exemplary user interface 1500 showing performance outcome on a user basis or median plan basis. As shown in FIG. 15, the user interface 1500 depicts a performance view for a specific user or a specific media plan in the area 1502. The performance data are categorized into three listings: client details, channel details, and publisher details. Client details lists the overall performance data for a user cross all media plans or for a media plan across all platforms and channels. Channel details lists the performance data related to the respective channels, including but not limited to search, social media, display, and shopping. Publisher details lists the performance data on the respective platforms. In the example shown in FIG. 15, performance indexes or metrics such as the total spend, average conversion rate are shown. However, other indexes or metrics that may interest the user can be shown, such as CPI, CPV, CPC, CPI, and so on. The user interface 1500 may also allow user to choose which indexes or metrics including a customized metrics to show in the performance quick view. In addition, some shortcuts to the functionalities that the user is interested are shown in the area 1504 to provide convenience, such as active alerts, alter, campaign/media plan builder, etc.

FIG. 11B illustrates an exemplary user interface 1120 showing user interaction data and metrics to the user in another more visualized way. As shown in FIG. 11B, the user interface 1120 shows the metrics and performance data in three categories based on their recent changes over time. In the left column 1122, the performance variables and metrics that may have issues that need immediate attention are shown in red or other colors, such as gray of a first shade degree. In the middle column 1124, the performance variables and metrics which the user is recommended to review is shown in yellow, such as gray of a second shade degree. In the right column 1126, the variables and metrics that are normal are shown in green or other colors, such as gray of a third shade degree. The categorization and the color code are just exemplary. In other embodiments, the performance variables and metrics can be categorized in other ways and into various categorization numbers. The categorization can be differentiated from each other with a different color code, or by marks, their positions, and so on. For example, if a change of a variable in the user interaction data or a metric over a predetermined time period is greater than a first limit, the variable or metric will be categorized as the first category that needs immediate attention. If a change of a variable in the user interaction data or a metric over a predetermined time period is between the first limit and a second limit that is smaller than the first limit, the variable or metric will be categorized as the first category that recommend the user to review. The remaining variables and metrics are categorized in the third category that does not require attention from the user. In one embodiment, the first and second limits are respectively set for each of the variables and metrics in which the user is interested. The user may also be allowed to change the first and second limits. In another embodiment, the variables and metrics may be categorized based on other factors than priorities and may be shown in other visual scheme or color scheme.

As shown in FIG. 11B, each of the variables and metrics are shown in a block. When a user clicks, touches or otherwise interacts with a block, the block may deploy and show a curve diagram illustrating the change of the corresponding variable or metrics over time. In another embodiment, the curve diagram may show up without requiring interaction with the user. In addition, for a variable or metric that needs the user's attention, the corresponding block may also include a text indicating the change of the variable or metric in percentage, as shown in FIG. 11A.

FIG. 11C illustrates an exemplary user interface 1140 that allows a user to customize the limits of the change of a variable or metric that triggers which level of alert. As shown in FIG. 11C, the area 1142 allows the user to set the name, status, and access control of the alert trigger. The area 1144 lists the alert triggers and allows user to select and edit an alert trigger or add a new alert trigger. The area 1146 allows the user to set the respective ranges of the variable or metric change that correspondingly triggers the respective level of alert. In the example shown in FIG. 11, the user may move the slides to set limits of the ranges corresponding to the respective alert levels. The range in red requires the immediate attention, and if the change of the variable or metric falls into this range, the corresponding information will be listed in the red column in FIG. 11B. The range in green requires the least attention, and if the change of the variable or metric falls into this range, the corresponding information will be listed in the green column in FIG. 11B. Likewise, the range in yellow corresponds to the yellow column in FIG. 11B. The digital marketing management system 400 may thus allow user to customize the criteria of a specific variable or metric to trigger different levels of alerts.

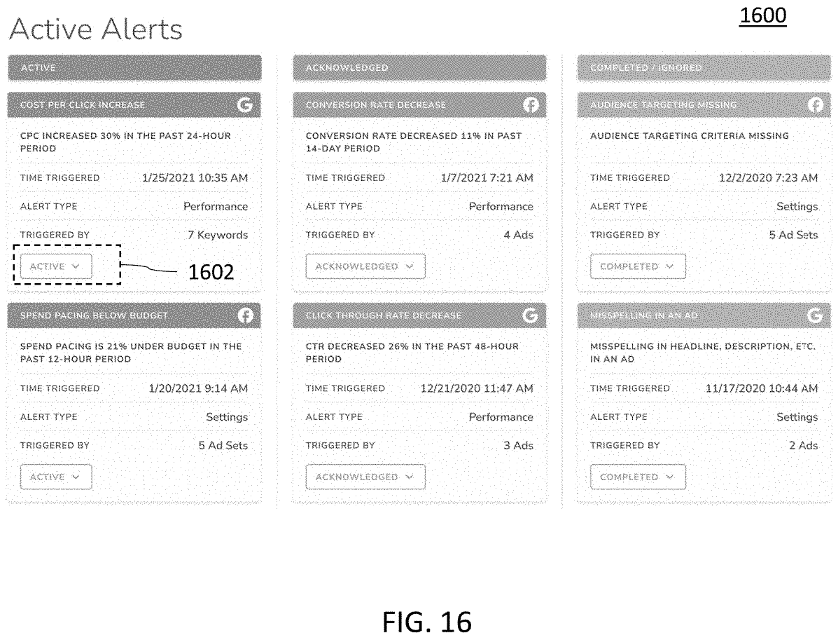

In another embodiment, the digital marketing management system 400 allows the user to tag and show the alerts based on their status. FIG. 16 illustrates another exemplary user interface 1600 showing the alerts to the user in a visualized way. As shown in FIG. 16, each shown alert further includes a drop-down block 1602, showing the current status of the alert and allowing the user to change the status. In the example shown in FIG. 16, the status may be one of Active, Acknowledged, and Completed. Active refers to an alert that is currently active and waiting to be handled. Acknowledges refers to an alert that a user has noticed and acknowledged. Completed refers to an alert that the corresponding incident has been properly handled or resolved. The user may also change the status of an alert by clicking the drop-down block 1602 and selecting the corresponding status. The alerts may also be presented in different columns based on their status, as shown in FIG. 16. It may help the user to keep track of the alerts based on their status. It is also particularly helpful when a plurality of users have access to and are responsible for handling the alerts. It should be understood that the status of alerts is just an example. The alerts may be tagged by the user based on other variables such as alert type, frequency of alerts, a variable customizable by the user, among the other.

In one embodiment, the digital marketing management system 400 may send alerts to the user based on rules that may be preset or added and edited by the user. In one embodiment, a conditional metric may be set as the rules, and an alert may be sent to the user when the conditional metric becomes true. The conditional metrics that the user may want to get alerted may be related to account performance, budget pacing, account and campaign targeting, and so on. For example, one conditional metric as a trigger for alert may be: if an advertisement spend for 12-hours period exceeds a user specified amount and the current date is prior to a user specified end date, an alert is sent. Another example may be: if advertisement groups included in a search advertisement do not include a user specified keyword and the campaign status is active, an alert is sent.

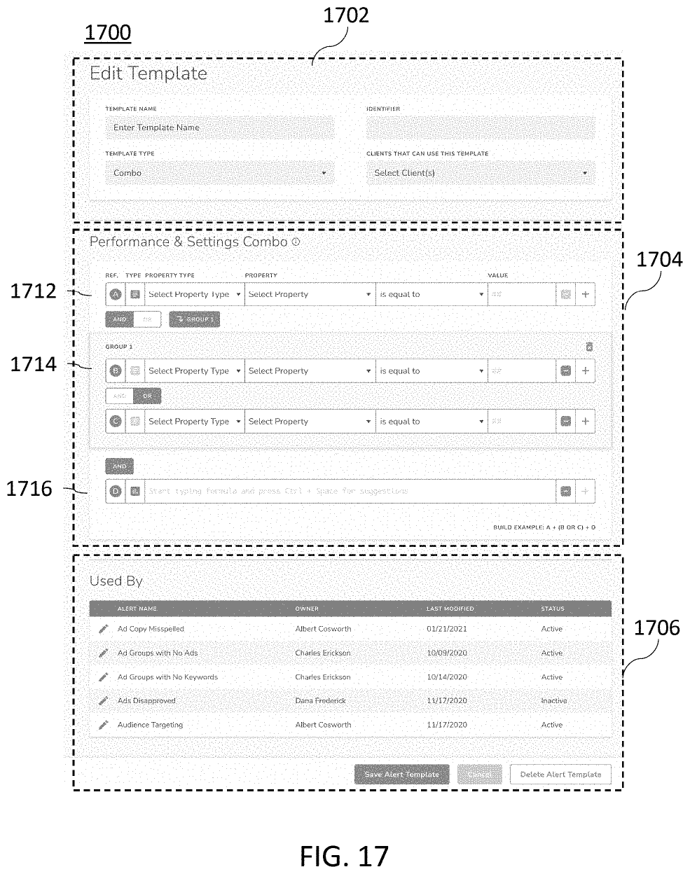

In another embodiment, the user is allowed to set a condition triggering an alert that is a combination of multiple of metrics and variables, for example, a combination of performance-based condition and setting based condition. These conditions can be combined with each other into a single condition by logic operators such as “AND” and “OR.” FIG. 17 illustrates an exemplary user interface 1700 that allows a user to set a complex condition for triggering an alert. As shown in FIG. 17, a user may set the alert name and type of the alert in the area 1702. The alerts that are set are shown in the area 1706 and the user may edit or delete these alerts. In the area 1704, the user may set the complex condition in a visualized way. The row 1712 allows the user to select a metric and corresponding operator to set a performance-based condition. The row 1716 allows the user to set a customizable formula as a setting based condition. The form and editing manner may be similar to the customizable metrics as described referring to FIGS. 10A-10C. In addition, the user may also set a plurality of conditions connected by logic operator in a group as shown by the row 1714. These conditions and condition group(s) can be connected by logic operators such as “AND” and “OR” as shown in FIG. 17. Therefore, the group functions as parenthesis in a logic formula. In addition, the user may add more performance based or setting based conditions and condition groups by clicking the “+.” The exemplary user interface 1700 thus provides the user with a tool to set up a complex condition as a trigger of an alert.

In one embodiment, the digital marketing management system 400 is configured to send an alert repetitively at a time interval that is configurable by the user. For example, the time interval for alerts that are at a higher priority and thus require immediate attention of the user may be set shorter than that for the alerts that are at a lower priority.

The channel of the alert may be selected based on the user terminal and as the circumstance may require. For example, the alert may be sent to the user via at least one from the group including a prompt on a screen, a sound, an email sent to an email address designated by the user, and a text messenger sent to a phone number designated by the user.

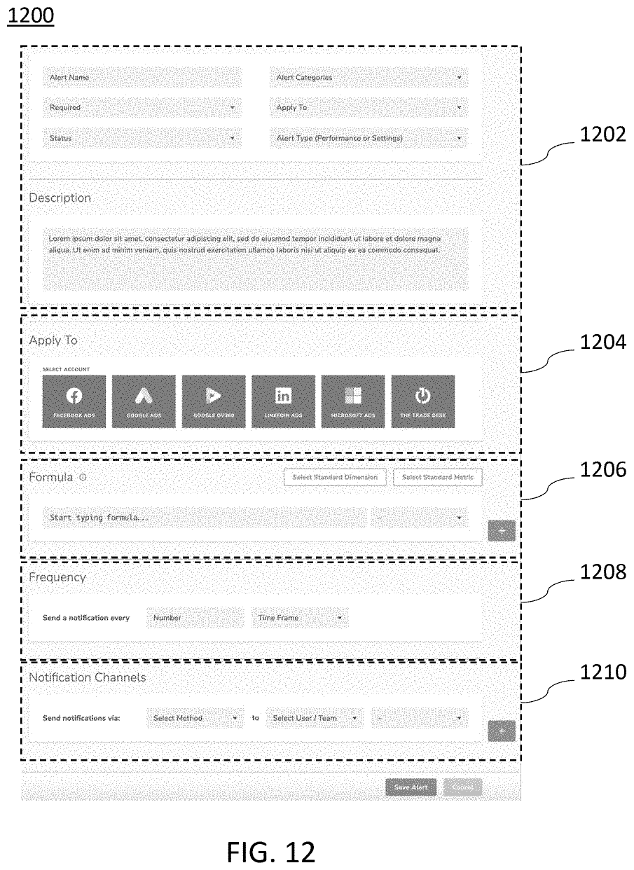

FIG. 12 illustrates an exemplary user interface 1200 for receiving alert setting from a user. The user interface 1200 may be used for the user to add a new alert or edit an existing alert. As shown in FIG. 12, in the area 1202, a few input and drop-down boxes are provided for receiving the name, description and other settings of the alert. In the area 1204, the user may select the digital marketing platform and the account that the alert is applied to. If the user selects one or more digital marketing platforms, it will be further prompted for the user to select one or more accounts under each selected digital marketing platform that the alert is applied to. In the area 1206, an input box is provided for receiving the formula that triggers the alert. Similar to metrics, the formula may comprise the variables of the user interaction data, metrics, and operators. In another embodiment, the formula may be visually editable as shown in FIG. 10B. In further another embodiment, the user may select one or more metrics from the existing metrics as the alert formula or as the base of the alert formula which the user may edit into the finalized alert formula. In the area 1208, settings of frequency of the alert may be received. The alert will be kept sending in the set frequency until the user makes a proper response. In the area 1210, the channel of alert may be selected. For example, the alert may be sent to the user via at least one from the group including a prompt on a screen, a sound, and a text messenger sent to a phone number designated by the user.

In another embodiment, the digital marketing management system 400 further allows the user to categorize the alerts, such as into categories of budget monitoring, performance, etc.

Alert Group

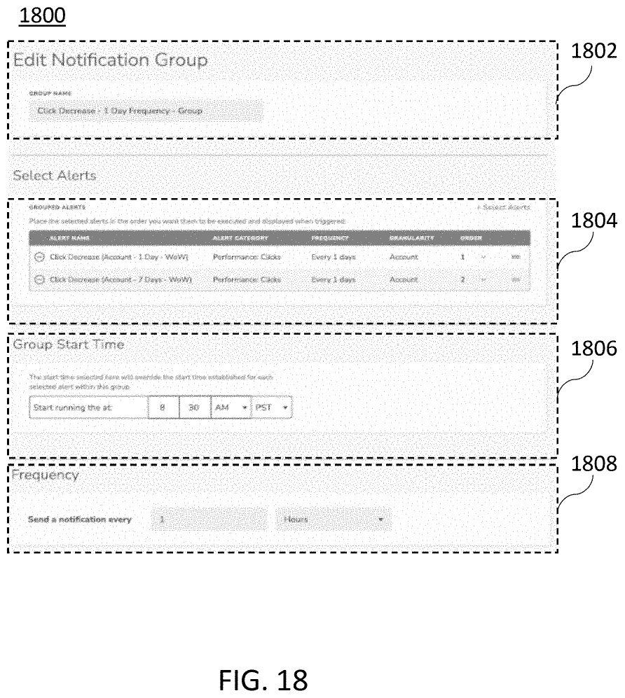

In one embodiment, in addition to categorization of alerts, the user is allowed to customize the actions based on the categorization of the alert triggers. FIG. 18 illustrates an exemplary user interface 1800 of the digital marketing management system 400 according to an embodiment of the invention. The user interface 1800 allows the user to create a group of alert triggers and set the method of alert delivery (e.g. email, text message), the running time and frequency limit or sending time and frequency limit of the alerts triggered by the alert triggers in the same group. In addition, the alerts in the same group may be pushed to the user together instead of separately.

As shown in FIG. 18, the user may add a new alert group though the user interface 1800. Specifically, the user may add the group name at the block 1802, select and add alert triggers in the group at the block 1804, and set the running start time at the block 1806 and the running frequency at the block 1808. In the example show in FIG. 18, two alert triggers are grouped together, that is, the decrease of daily average of clicks and the decrease of weekly average of clicks. In addition, the running start time is set at 8:30 am and the frequency of sending notifications for the group is set at one notification per hour. Therefore, the digital marketing management system will run the formulas or metrics defined in two grouped alert triggers once per hour after 8:30 am, and only send a notification to the user if any one of the alerts is triggered. In addition, if both of the two grouped alerts are trigger, the digital marketing management system may send one notification including both alerts to the user. Additionally, but not shown in the figure, the user can select which alerts are received by which methodology, outlining which ones are higher priority and need to be sent via text message versus others that are sufficient via email notification.

The user interface 1800 is just an example and may be revised based on the application of the digital marketing management system. The use interface 1800 may allow more than two alert triggers to be included in a group. In addition, a running stop time may be set in addition to or instead of the running start time. The frequency of sending notification may be set base on any other time units besides hour. Additionally, users can customize configuration settings that would monitor changes specific to live-running campaigns within the account to trigger alerts to the end user.

In another embodiment, instead of running the metrics, configuration settings, or formulas of the alert triggers at the preset frequency, the digital marketing management system may also monitor the related metrics or formulas continuously or every time when the variables are updated. In this embodiment, if any of the alerts in the group is triggered, the notification of the corresponding alert will be temporarily stored in a buffer, and only be sent to the user when the time is up based on the preset frequency.

Therefore, the digital marketing management system 400 allows to have a plurality of alerts grouped together arbitrarily, and send the notification to the user, when any of the grouped alerts is triggered, only at a predetermined time. The notification may include all the alerts that have been triggered. The predetermined time may be in turn set based on the frequency of the notification. The period during which the notification of grouped alerts can be sent to the user may also be set by the user.

The grouped alerts provides a mechanism to organize the notifications in various manners. It may provide the alerts that are related to each other altogether in a single notification, it also makes it possible to adjust the period and the frequency that the related alerts may be prompted to the user. It may be further integrated into other types of notifications. For example, a morning digest may be provided to the user with a summary of interested metrics and variables, and a group of alerts that were triggered overnight may also be included in the summary by utilizing this mechanism. It thus makes it possible to provide the user with well-organized information and notifications without disturbing the user with, for example, multiple notifications in a short period or at an unexpected time. The system also self-references alerts that have been sent or are still running and prevents other alert notification groups from starting, keeping relevant information grouped together. It also prevents a notification from being buried in a plurality of notifications and missed by the user.

Edit Lock

In one embodiment, the digital marketing management system 400 may comprise an edit lock module.

For example, the digital marketing management system 400 may comprise an edit lock module that prevent overlapping efforts on metrics and alerts. As aforementioned, the metrics and alerts are customizable by the user. When two sessions or users try to update or delete the same alert or metric, there will be a concurrent update conflict. In order to avoid this problem, the digital marketing management system 400 may lock the data related to the alert or metric for the first user and only allow the first user to update and delete the data. When a second user views or tries to update or delete the same alert or metric, the digital marketing management system 400 may prompt the second user that the alert or metric is being edited by another user by, for example, showing an icon or note besides the alert or metric, or providing a pop-out window with an alert.

In addition, the digital marketing management system 400 may further comprise an edit lock time out module. When the first user, during updating or deleting an alert or metric, idles (that is, stops making any actions) for a predetermined idle time, the digital marketing management system 400 will release the lock without making any changes to the data and thus allow a subsequent session or user to update or delete the related data. The predetermined idle time may be set according to the application of the digital marketing management system, and may be, for example, 5 minutes, 10 minutes, 15 minutes, or any other period. In another embodiment, the predetermined time may be adjustable by the user.

In this case, optionally, when the predetermined time has passed, the digital marketing management system 400 may prompt the first user that the session has timed out without having any changes saved. Furthermore, the digital marketing system 400 may further prompt the first user that the session will time out when the first user has idled for a predetermined wait time, which is shorter than the idle time. For example, the wait time may be shorter than the idle time by 1-5 minutes, or 10-20%, or any other period, depending on the length of the idle time and the specific application. Optionally, the digital marketing system 400 may also show a timer to the user when prompting that the session will time out.

It shall be understood that the edit lock module may be applied to other components of the digital marketing system 400 that may be edited by a user. For example, during the media planning and campaign automation routine as shown in FIG. 6, when the digital marketing system 400 is receiving edits from a first user (such as, media planning settings, campaign settings, advertisement content library, or advertisement or advertisement group settings), or generating advertisements and submitting settings and advertisements to respective digital marketing platforms, a similar edit lock may be triggered to prevent any other users to edit or delete related settings and content. A prompt, such as, an icon or an alert may be provided to any other users who attempt to make such overlapping efforts. In addition, a similar edit lock time out module may be applied, to end the session for the first user after a predetermined idle time, prompt the first user about the time out, and allow a second user to edit or delete related settings and content when the session for the first user is ended.

Automated Decision Maker

Below, the automated decision maker module 450 according to one embodiment of the present invention will be described by referring to FIG. 13. FIG. 13 is a flow chart of automated decision maker routine that may assist the user to choose one or more advertisements that have better performance from all the optional advertisement generated by the media planning and campaign automation routine.

As aforementioned, when the media planning and campaign automation routine as shown in FIG. 6 has generated optional advertisements at step 660, the optional advertisements are usually permutations of entries of elements selected from the campaign library that constitutes an advertisement based on the standard of the corresponding digital marketing platforms. The user may not necessarily know which one can perform better than the others. Therefore, the user may choose automated decision maker module to assist the user to make the choice. Thus, the automated decision maker routine starts at step 1310.

The automated decision maker routine then goes to step 1320, where the routine receives from the user the selection of candidate advertisements from the generated optional advertisements. The user may select from at least two to all of the optional advertisements as the candidate advertisements. However, in some embodiments, an upper limit of the number of candidate advertisements can be preset.

In another embodiment, the automated decision maker routine may also take all or select some of the optional advertisements generated by the media planning and campaign automation routine as the candidate advertisements without requesting the user's selection. In one example, these optional advertisements are of the same type and to be run on the same platform. In another example, these optional advertisements may be of different type or to be run on different platforms. In this case, if the automated decision maker routine is set to select candidate advertisements automatically, it will select at least one from each type or each platform.

Next, at step 1320, the automated decision maker routine submits each of the candidate advertisements to the corresponding platforms to be run for a predetermined time period. The predetermined time period can be preset, for example, a predetermined number of days, weeks, or months. The predetermined time period can also be set by the user. In one embodiment, the predetermined time period can also be set to be a flexible time period until the performance data are statistically sufficient to compare the candidate advertisements. For example, the end time point can be set when the number of views, clicks, conversions, or any concerned performance index is sufficient to reach the conclusion in a predetermined confidence interval (for example, 90%, 95%, or 99%). In this case, the automated decision maker routine will also retrieve and monitor the performance data of the advertisements frequently.

Next, at step 1330, when it reaches the end point of the time period, the automated decision maker routine receives the performance data of each candidate advertisement from the digital marketing platform. As aforementioned, the content of performance data largely depends on the type of the advertisement and the platform. Examples of the index and metrics that may be included in the performance data include usually comprise at least one from the group consisting of impressions, clicks, impression share, views, view rate, phone calls, interaction rate, cost, cost per interaction (CPI), cost per click (CPC), click through rate (CTR), conversion, conversion rate, and optimization score.

After having received the performance data, in one embodiment, the automated decision maker routine provides the performance data to the user at step 1380. The performance data may be shown in an organized way, such as the table shown in the block 1108 in FIG. 11A. The user may also choose the advertisement to be listed in the order of a selected performance index or metrics. The user may then make a decision which one or ones of the candidate advertisements shall be selected as finalized advertisement to run.

Alternatively, the automated decision maker routine may go to steps 1350-1370 to select recommended advertisements automatically. At step 1350, the automated decision maker routine determines the performance target of the advertisements. In one embodiment, the goal of the corresponding media plan or campaign can be retrieved as the goal of the advertisements. The goals may include brand awareness, consideration (intended consumer engagement such as clicks), and conversion (intended consumer conversion such as visits to a website, app downloads, and phone calls), among the others. In another embodiment, the goal for the advertisement can be received from the user. The goal will affect the factors and their weights when the automated decision maker routine decides one or more recommended advertisement. For example, if brand awareness is the main goal, the views of the advertisement will be considered and be allocated a higher weight. If the consideration is the main goal, the consumer engagement such as clicks of the advertisement will be considered and be allocated a higher weight. If the conversion is the main goal, the conversions and conversion rate of the advertisement will be considered and be allocated a higher weight.

Next, at step 1360, the automated decision maker routine decides one or more recommended advertisements from the candidate advertisements based on their performance data. The related index and metrics in the performance data and their weights will be considered. Below, a few examples are described.

### Example I

In Example I, the main factors related to the goal of the advertisements are considered. For example, when the goal is brand awareness for a display advertisement, views may be considered. When the views (i.e., the number of views of the advertisement) for each candidate advertisement are retrieved, a normalized number of views for each candidate advertisement is calculated by a percentage of views for the candidate advertisement in the overall views of all the candidate advertisement. The automated decision maker routine then calculates a performance score for each candidate advertisement which equals to the normalized views. The one or more candidate advertisements that have a higher performance score than the remaining are decided as the recommended advertisements.

### Example II

Example II is similar to Example 1 except an additional factor, clicks (i.e., the number of clicks on the link in the advertisement) are further taken into account. In this case, each factor is allocated a weight. For example, a weight a1=70% is allocated to views while a weight a2=30% is allocated to clicks. The performance score may be represented by the equation below: S=F1*a1+F2*a2, wherein S refers to performance score, F1 and F2 refer to the normalized performance indexes, and in this case, normalized views and normalized clicks, respectively, and a1 and a2 are their weights and a1+a2=100%. Similarly, the automated decision maker routine chooses one or more that have higher performance score than others as the recommended advertisements.

As can be understood, when more factors are considered, the performance score may be represented by the equation below: S=F1*a1+F2*a2+ . . . Fn*an, wherein Fi, i=1−n, refers to a normalized performance index; ai, wherein i=1−n, and n is an integer, refers to the weight of Fi; and the sum of “a1” to “an” equals to 100%.

### Example III

Example III is similar to Example II except that the cost that is charged by the platform on each advertisement is further considered. In this case, the performance score may be represented by the equation below: S=(F1*a1+F2*a2+ . . . Fn*an)/C, wherein C refers to the cost. In this regard, the most cost-efficient advertisements can be determined.

As can be understood, Examples II and III also apply when there is only one performance index is considered. In this case, the weight of other indexes can be set to zero.

The number of recommended advertisements can be preset by the user, for example, 1 or 2, or top 10%. In another embodiment, the automated decision maker routine may simply select the advertisement that has the best performance (the highest performance score) as the recommended advertisement. In further another embodiment, the automated decision maker routine may select the advertisement that yields the best performance, and also select one or more remaining advertisements that have a similar performance to the best one (for example, an advertisement with a performance score that is lower by no more than a predetermined level, for example, 5% or 10%, or an advertisement with a performance that is not statistically different from the best one with a confident interval of 95% or 90%).

It can also be understood that one skilled in the art may use other methods to decide the performance order of the candidate advertisements.

When the one or more recommended advertisements are decided, the routine may provide them to the user for final approval. In another embodiment, the routine may employ the recommended advertisements as finalized advertisements, and then remove the remaining advertisements from the corresponding platforms or suspend the running of them.

Data Retrieval Failsafe

In one embodiment, the digital marketing management system 400 may further comprise a data retrieval failsafe module. As aforementioned, the digital marketing management system 400 retrieves data from the digital marketing platforms from time to time. For example, the digital marketing management system 400 retrieves customer interaction data to be used by the performance analysis module 430 and provides outcome data and alerts to the user periodically. However, sometimes the digital marketing management system 400 may not be able to retrieve a complete data set from one or more platforms due to, for example, network issues, platform malfunction, among others. The data retrieval failsafe module is designed to keep the system running in this case without significantly consuming the resource of the network or the computing device.

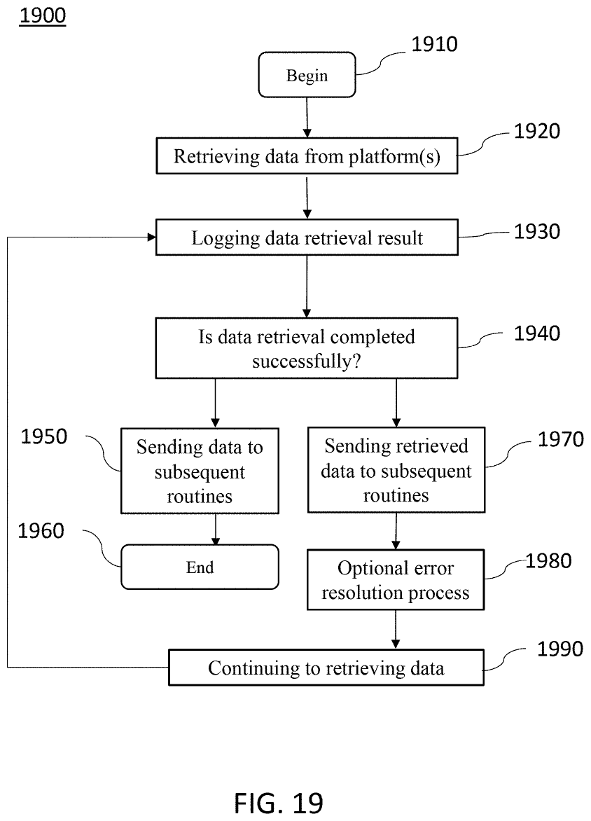

FIG. 19 illustrates a flow chart of data retrieval failsafe routine 1900 according to one embodiment of the invention. As shown in FIG. 19, the data retrieval failsafe routine 1900 starts at the step 1910. The routine 1900 may be initiated at a prescheduled time, manually by a user, or by other conditions. For example, the routine 1900 may be initiated at a prescheduled time every day, or at any other predetermined time intervals. The routine 1900 may also be initiated upon a user's request. In addition, the routine 1900 may be initiated by conditions such as, a push notification from a platform, among others.

The routine 1900 then goes to the step 1920, retrieving data from the digital marketing platform(s), for example, the performance data. The routine 1900 will connect to the related digital marketing platform(s), provide the corresponding account authorization credentials, and retrieve the corresponding data.

Next, at step 1930, the routine 1900 records the data retrieval result in a log to indicate which data have been retrieved successfully and which have not. Depending on the application, the data retrieval result may be logged based on the hierarchy of platform, account of the platform, or each data entry. The routine 1900 then, at step 1940, determines if data retrieval is completed successfully. If so, the routine 1900 will, at step 1950, send data to subsequent routines, such performance analysis module 430, or routines for providing dashboard output and alerts to the users.

Otherwise, if the routine 1900, at step 1940, determines that data retrieval has not been completed successfully, the routine 1900 goes to step 1970. This may occur, for example, when there is a networking issue or one of the platforms has a malfunction. At step 1970, the routine 1900 sends what have been retrieved to subsequent routines. Optionally, the routine 1900 may further run other error resolution process at step 1980, for example, sending an alert to a related user.

The routine 1900 then proceeds to step 1990 and continues to retrieve data that has not been successfully obtained from the corresponding platform(s). Next, the routine 1900 goes back to step 1930.

The data retrieval failsafe routine may prevent a complete down time caused by incomplete or unsuccessful data retrieval, thus avoiding scheduling delays for interdependent business. It should be understood that the data retrieve failsafe routine could be applied in almost any field that requires data retrieval from a server, either in a scheduled or real-time manner.

Media Mix Model

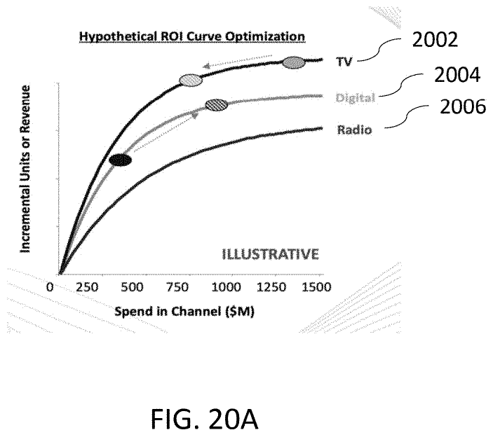

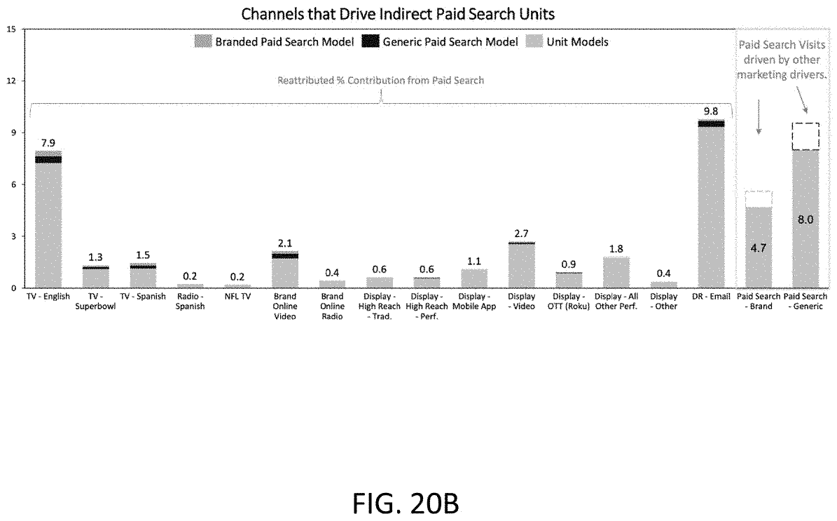

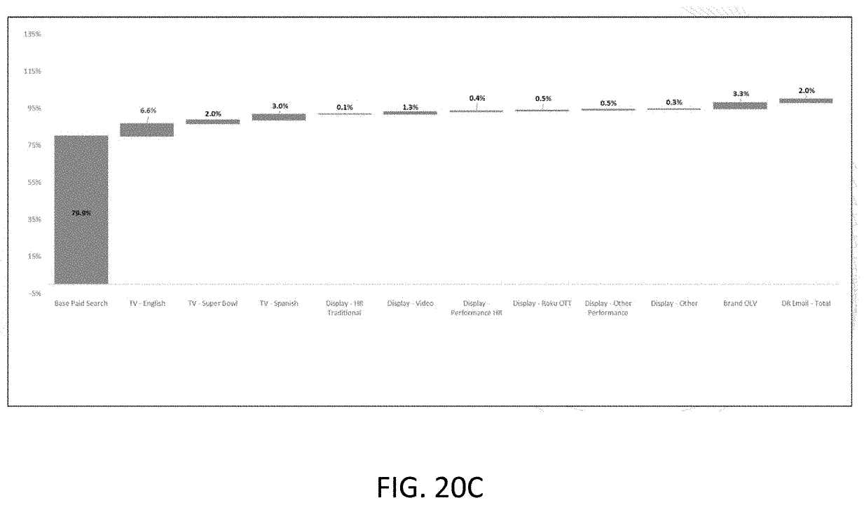

Below, a media mix model according to one embodiment of the present invention will be described by referring to FIGS. 20A-C. The media mix model is configured to perform an analysis on media performance data that determines impact of channels, publishers, and campaigns and how various factors contribute to driving desired business outcomes.

Specifically, a user may advertise a product or service through multiple channels, publishers and campaigns including traditional channels such as TV and radio, and online marketing, such as keyword search, display of images and videos on mobile Apps, and so on across various digital marketing platforms. In this case, the conversion directly provided by the respective platforms may not reflect the actual contribution of each platform to the overall desired business outcome. For example, some of the consumers, after watching a video display on Instagram or TV, may go search on Google and click on a paid keyword advertisement and make purchases, this will be caught by Google as conversions through paid keyword search. However, in this case, the video display drove the paid search and indirectly contributed to these conversions. The media mix model thus may reattribute these desired business results among the channels, publishers, and campaigns to better project the contributions of them and provide a tool for the user to allocate future spending, especially when the consumers' activities across platforms are not readily tracked.

The media mix model according to one embodiment is based on a few models. The basic model is the hypothetical return on investment (“ROI”) against spending in each of channel, publishers, or campaigns alone assuming that no other channels, publishes or campaigns have been utilized for the marketing. The basic model is obtained through statistical analysis of years of historical data, for example, through factor analysis. FIG. 20A illustrates exemplary curves of ROI against spending of a few different channels. In FIG. 20A, the horizontal ordinate represents the spending in million dollars, the vertical ordinate represents ROI, specifically, incremental units sold or revenue generated. The curve 2002 shows how ROI changes with the spending through TV, the curve 2004 shows those though digital marketing, and the curve 2006 shows those through radio. In the example shown in FIG. 20A, all three channels exhibit similar tendency of ROI with the change of spending. The ROI increases rapidly when spending increases from zero. However, the increasing slope becomes gentle when more spending is invested. In addition, the channel generally yields more ROI than digital or radio. The curves shown in FIG. 20A are illustrative. These curves are decided by the model and the historical data, and may change over time while being affected by various factors, such as, the fluctuation of the unit price through each channel, the change of popularity of each channel, among others. In addition, this model may also be applied to analysis of platforms and campaigns by categorizing the conversion sources in a more detailed manner. For example, TV channel may further include TV campaigns in various languages, TV campaigns through different channels (sports, news, entertainments, etc.). paid keyword research may be further divided into paid generic keyword search in which the keyword is generic to the product or service and paid branded keyword search in which the keyword include the brand information.

The media mix model may further run the data against a reattribution model to determine the projected actual contributions to the desired business outcome from each platform, channel, or campaign. The reattribution model may be established by factor analysis of statistic data, or by machine learning through neural network. FIG. 20B illustrates a bar graph showing an example of how the reattribution result of one example according to one embodiment of the invention could look. In FIG. 20B, each bar represent the percentage contribution of a specific campaign or channel to the overall business outcome. The portion in solid line of each bar represents the reattributed percentage contribution which further includes indirect contribution through other campaign or channel that is projected, the portion in dotted line represents the percentage contribution that is captured by corresponding campaign or channel but is projected as being reattributed to other campaigns or channels. The representation of reattributed portions in the respective outlines and colors are exemplary, they can be illustrated in other ways to differentiate from each other when appropriate, for example, by using different crosshatch patterns.

As shown in FIG. 20B, the two bars in the right are the contribution to the desired business outcome of paid branded keyword search and paid generic keyword search. As projected by the media mix model, the portions in dotted line are reattributed to other platforms, channels, and campaigns. That is to say, the corresponding portions of the conversion are generated by consumers getting aware of the product or brand through other platforms, channels, and campaigns before making the search.

In the remaining bars, the portions of direct and indirect conversions are indicated in different colors. For example, in the bar for “TV-English” representing the percentage conversion through a TV campaign in English, the gray portion is direct conversion, the dark blue portion is indirect conversion through paid generic keyword search, that is, the conversion made by consumers who were exposed to the TV campaign and then made the purchase through searching a paid generic keyword; while the light blue portion is indirect conversion through paid branded keyword search, that is, the conversion made by consumers who were exposed to the TV campaign and then made the purchase through searching a paid branded keyword.

The same data may be illustrated in different ways. For example, FIG. 20C illustrates the projected percentage conversion of each platforms, channels, and campaigns. Each bar represents the percentage of conversion generated through platforms, channels, and campaigns in the overall conversion. In FIG. 20C, the reattributed portions are not indicated.

FIGS. 20B and 20C are exemplary graphs showing the result of the media mix model. The media mix model may be applied to analysis of conversions captured by other platforms and channels other than keyword search or the overall conversions captured across platform and channels.

While the foregoing specification has been described with regard to certain preferred embodiments, and many details have been set forth for the purpose of illustration, it will be apparent to those skilled in the art without departing from the spirit and scope of the invention, that the invention may be subject to various modifications and additional embodiments, and that certain of the details described herein can be varied considerably without departing from the basic principles of the invention. Such modifications and additional embodiments are also intended to fall within the scope of the appended claims.

What is claimed:

1. A digital marketing management method, implemented by at least one computing system, comprising:
receiving an authorization to access at least one digital marketing platform that distributes digital marketing content to a consumer through a network;
retrieving, from the at least one digital marketing platform, consumer interaction data describing an effect of consumer interaction with the digital marketing content;
receiving, from a user, at least one customized metric which is calculated by a formula of the consumer interaction data;
calculating the at least one customized metric;
generating outcome data based on the customized metric and the consumer interaction data; and
outputting a result based on the outcome data to the user.

2. The method of claim 1, wherein the at least one customized metric comprises a conditional metric that is calculated by a formula including logic operation.

3. The method of claim 2, further comprising: outputting an alert to the user when, as an alert trigger, the conditional metric is true.

4. The method of claim 3, wherein the alert comprises at least one from the group including a prompt on a screen, a sound, an email sent to an email address designated by the user, and text sent to a phone number designated by the user.

5. The method of claim 3, wherein the alert comprises an attention level information that indicates an attention level the user shall be called.

6. The method of claim 5, wherein the attention level information is categorized based on a change of at least one of the customizable metric and the consumer interaction data, and a correspondence between the attention level information and the change is received from the user.

7. The method of claim 3, wherein the alert is sent repetitively at a time interval that the user is able to change.

8. The method of claim 3, further comprise:
receiving from the user an alert group comprising a plurality of alert triggers;
receiving from the user a predetermined time or frequency at which an alert triggered by any of the plurality of alert triggers in the alert group is to be sent;
at the predetermined time or frequency, if at least one alert is triggered, sending every and each triggered alert together as a grouped alert to the user.

9. The method of claim 8, wherein the group alert comprises at least one from the group including a prompt on a screen, a sound, an email sent to an email address designated by the user, and text sent to a phone number designated by the user.

10. The method of claim 1, wherein retrieving consumer interaction data comprises retrieving the consumer interaction data repetitively at a first preset time interval.

11. The method of claim 2, wherein the at least one metric comprises a metric that is calculated based on a change of the consumer interaction data over time.

12. The method of claim 1, wherein the consumer interaction data comprises at least one from the group consisting of impressions, clicks, impression share, views, view rate, phone calls, interaction rate, cost, spend, conversion, conversion rate, and optimization score.

13. The method of claim 1, further comprising:
calculating at least one preset metric; and
wherein generating outcome data comprises generating the outcome data based on the at least one preset metric and consumer interaction data.

14. A digital marketing management system comprising:
a management device connected to a network; and
a user device connected to the network, comprising a user interface for a user to interact with the management device;
wherein the management device comprises at least one processor and memory coupled to the at least one processor, the memory comprising computer executable instructions that, when executed by the at least one processor, performs a method comprising:
receiving an authorization to access at least one digital marketing platform that distributes digital marketing content to a consumer through the network;
retrieving, from the at least one digital marketing platform, consumer interaction data describing an effect of consumer interaction with a digital marketing content;
receiving, through the user device, at least one customized metric which is calculated by a formula of the consumer interaction data;
calculating the at least one customized metric;
generating outcome data based on the at least one customized metric and the consumer interaction data; and
outputting a result based on the outcome data to the user device.

15. The system of claim 14, wherein the at least one customized metric comprises a conditional metric that is calculated by a formula including logic operation.

16. The system of claim 14, wherein the management device is configured to output an alert to the user when, as an alert trigger, the conditional metric is true.

17. The system of claim 16, wherein the alert comprises at least one from the group including a prompt on a screen, a sound, an email sent to an email address designated by the user, and text sent to a phone number designated by the user.

18. The system of claim 14, wherein the alert comprises an attention level information that indicates an attention level the user shall be called.

19. The system of claim 18, wherein the attention level information is categorized based on a change of at least one of the customizable metric and the consumer interaction data, and a correspondence between the attention level information and the change is received from the user.

20. The system of claim 16, wherein the alert is sent repetitively at a time interval that the user is able to change.

21. The system of claim 16, further comprise:
receiving from the user an alert group comprising a plurality of alert triggers;
receiving from the user a predetermined time or frequency at which an alert triggered by any of the plurality of alert triggers in the alert group is to be sent;
at the predetermined time or frequency, if at least one alert are triggered, sending every and each triggered alert together as a grouped alert to the user.

22. The system of claim 14, wherein the management device is configured to retrieve the consumer interaction data repetitively at a preset time interval.

23. The system of claim 22, wherein the at least one customized metric comprises a metric that is calculated based on a change of the consumer interaction data over time.

24. The system of claim 14, wherein the consumer interaction data comprises at least one from the group consisting of impressions, clicks, impression share, views, view rate, phone calls, interaction rate, cost, spend, conversion, conversion rate, and optimization score.

25. The system of claim 14, the management device is further configured for:
calculating at least one preset metric; and
generating outcome data based on the at least one preset metric and consumer interaction data.

26. A digital marketing management method, implemented by at least one computing system, comprising:
receiving an authorization to access at least one digital marketing platform that distributes digital marketing content to a consumer through a network;
receiving from the user an advertisement content library of at least one element required by the at least one digital marketing platform to form a digital marketing content, wherein the advertisement content library comprises at least one entry for each of the at least one element;
generating at least one digital marketing content in a form required by the at least one digital marketing platform by selecting at least one entry from each element required by the form;
submitting the generated digital marketing content to the corresponding digital marketing platform;
retrieving, from the at least one digital marketing platform, consumer interaction data describing an effect of consumer interaction with the digital marketing content;
receiving, from the user, at least one customized metric which is calculated by a formula of the consumer interaction data;
calculating the at least one customized metric;
generating outcome data based on the customized metric and the consumer interaction data; and
outputting a result based on the outcome data to the user.

27. A digital marketing management system comprising:
a management device connected to a network; and
a user device connected to the network, comprising a user interface for a user to interact with the management device;
wherein the management device comprises at least one processor and memory coupled to the at least one processor, the memory comprising computer executable instructions that, when executed by the at least one processor, performs a method comprising:
receiving an authorization to access at least one digital marketing platform that distributes digital marketing content to a consumer through a network;
receiving from the user an advertisement content library of at least one element required by the at least one digital marketing platform to form a digital marketing content, wherein the advertisement content library comprises at least one entry for each of the at least one element;
generating at least one digital marketing content in a form required by the at least one digital marketing platform by selecting at least one entry from each element required by the form;
submitting the generated digital marketing content to the corresponding digital marketing platform;
retrieving, from the at least one digital marketing platform, consumer interaction data describing an effect of consumer interaction with the digital marketing content;
receiving, from the user, at least one customized metric which is calculated by a formula of the consumer interaction data;
calculating the at least one customized metric;
generating outcome data based on the customized metric and the consumer interaction data; and
outputting a result based on the outcome data to the user.
